(19) United States
(12) Patent Application Publication
(10) Pub. No.: US 2026/0218654 A1
(43) Pub. Date: Jul. 30, 2026

(54) SYSTEM AND METHOD HAVING THERMAL CONTROL FOR GAS CAPTURE SYSTEM

(71) Applicant: GENERAL ELECTRIC TECHNOLOGY GMBH, Baden (CH)

(72) Inventors: Thanganadar DHINESH, Karnataka (IN); Anindya Kanti DE, Karnataka (IN); Subrata PAL, Karnataka (IN)

(21) Appl. No.: 19/157,915

(22) PCT Filed: Apr. 12, 2023
(86) PCT No.: PCT/US2023/018339

§ 371 Date: Aug. 19, 2025

(30) Foreign Application Priority Data
Feb. 24, 2023 (IN) 202311012768

(51) Int. Cl. F02C 6/18; B01D 53/04; G05D 7/01

(52) U.S. Cl. CPC F02C 6/18; B01D 53/0462; G05D 7/01; B01D 2257/504; B01D 2258/0283; B01D 2259/40007

(57) ABSTRACT

A system includes a gas capture system having a first adsorber with a first sorbent material and a first phase change material. The first sorbent material is configured to adsorb an undesirable gas from a gas flow during an adsorption mode. The first phase change material is configured to absorb heat during the adsorption mode to increase a capacity of the first sorbent material to adsorb the undesirable gas.

### BACKGROUND

The present application relates generally to a system and method for capturing undesirable gases associated with a combustion system, such as a combustion-driven power plant.

An industrial plant, such as a combustion-driven power plant, may produce a variety of gases, such as an exhaust gas of a combustion system. The combustion system may include a gas turbine engine, a reciprocating piston-cylinder engine, a furnace, a boiler, or other industrial equipment. These exhaust gases may include one or more undesirable gases, such as acid gases and/or greenhouse gases. For example, the undesirable gases may include carbon oxides (COx) such as carbon dioxide (CO₂) and carbon monoxide (CO), nitrogen oxides (NOx) such as nitrogen dioxide (NO₂), and/or sulfur oxides (SOx) such as sulfur dioxide (SO₂). CO₂ is both an acid gas and a greenhouse gas. Unfortunately, the atmospheric content of CO₂ has generally increased over thousands of years, and currently exceeds about 420 parts per million by volume (ppmv) or 643 parts per million by weight (ppmw) in the atmosphere. With various regulations and environmental concerns regarding global warming, it would be desirable to reduce the output of undesirable gases (e.g., CO₂) into the atmosphere, particularly for hydrocarbon fuel consuming equipment such as combustion systems.

### BRIEF DESCRIPTION

Certain embodiments commensurate in scope with the originally claimed subject matter are summarized below. These embodiments are not intended to limit the scope of the claimed embodiments, but rather these embodiments are intended only to provide a brief summary of possible forms of the subject matter. Indeed, the presently claimed embodiments may encompass a variety of forms that may be similar to or different from the embodiments set forth below.

A system includes a gas capture system having a first adsorber with a first sorbent material and a first phase change material. The first sorbent material is configured to adsorb an undesirable gas from a gas flow during an adsorption mode. The first phase change material is configured to absorb heat during the adsorption mode to increase a capacity of the first sorbent material to adsorb the undesirable gas.

A system includes a controller having a memory, a processor, and instructions stored on the memory and executable by the processor to selectively change operating modes of a gas capture system in a sequence of an adsorption mode, a desorption mode, and a cooling mode, wherein the gas capture system includes a first adsorber having a first sorbent material and a first phase change material. The controller is configured to control a gas flow through the first adsorber in the adsorption mode, wherein the first sorbent material is configured to adsorb an undesirable gas from the gas flow during the adsorption mode, and the first phase change material is configured to absorb heat during the adsorption mode to increase a capacity of the first sorbent material to adsorb the undesirable gas. The controller is configured to control heating of the first adsorber in the desorption mode, wherein the heating causes desorption of the undesirable gas from the first sorbent material. The controller is configured to control cooling of the first adsorber in the cooling mode, wherein the cooling regenerates the first phase change material prior to a subsequent operation in the adsorption mode.

A method includes selectively changing operating modes of a gas capture system in a sequence of an adsorption mode, a desorption mode, and a cooling mode, wherein the gas capture system includes a first adsorber having a first sorbent material and a first phase change material. The method includes controlling a gas flow through the first adsorber in the adsorption mode, wherein the first sorbent material is configured to adsorb an undesirable gas from the gas flow during the adsorption mode, and the first phase change material is configured to absorb heat during the adsorption mode to increase a capacity of the first sorbent material to adsorb the undesirable gas. The method includes controlling heating of the first adsorber in the desorption mode, wherein the heating causes desorption of the undesirable gas from the first sorbent material. The method includes controlling cooling of the first adsorber in the cooling mode, wherein the cooling regenerates the first phase change material prior to a subsequent operation in the adsorption mode.

### BRIEF DESCRIPTION OF THE DRAWINGS

These and other features, aspects, and advantages of the presently disclosed techniques will become better understood when the following detailed description is read with reference to the accompanying drawings in which like characters represent like parts throughout the drawings, wherein:

FIG. 1 is a block diagram of an embodiment of a combined cycle system having a gas turbine system, a steam turbine system, and a heat recovery steam generator (HRSG), and a gas treatment system having one or more gas capture.

FIG. 2 is a schematic of an embodiment of a gas capture system of the gas treatment system of FIG. 1, illustrating a sorbent-based gas capture system having an adsorption mode, a desorption mode, and a cooling mode.

FIG. 3 is a flow chart of an embodiment of a gas treatment process of the gas treatment system of FIGS. 1-2, such as the sorbent-based gas capture system.

FIG. 4 is a perspective view of an embodiment of the sorbent-based gas capture system of FIG. 2, further illustrating an embodiment of a contactor assembly and a thermal control system.

FIG. 5 is a partial side view of an embodiment of a contactor of the contactor assembly of FIGS. 2 and 4, further illustrating a plurality of fins protruding from a body of the contactor.

FIG. 6 is a cross-sectional side view of an embodiment of the contactor of the contactor assembly of FIGS. 2, 4, and 5, further illustrating an embodiment of a construction of the contactor.

FIG. 7 is a cross-sectional side view of an embodiment of the contactor of the contactor assembly of FIGS. 2, 4, and 5, further illustrating an embodiment of a construction of the contactor.

FIG. 8 is a schematic view of an embodiment of the thermal control system of FIGS. 2 and 4, further illustrating an embodiment of a cooling circuit, a heat exchanger, and heat pipes coupled to the contactor.

### DETAILED DESCRIPTION

One or more specific embodiments of the presently disclosed systems and methods are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the presently disclosed embodiments, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods to reduce the carbon footprint of combustion systems, such as combustion-driven power plants and/or combined cycle power plants, using a gas treatment system having one or more gas capture systems. The gas capture systems are configured to remove undesirable gases (e.g., CO₂) from the intake air and/or the exhaust gas of the combustion systems. The gas capture systems may include sorbent-based gas capture systems, solvent-based gas capture systems, cryogenic gas capture systems, or a combination thereof. For example, the gas capture systems (e.g., sorbent-based gas capture systems) may include one or more temperature swing adsorption (TSA) units or adsorbers, which rely on temperature swings to adsorb undesirable gases at a first temperature (e.g., low temperature) and desorb the undesirable gases at a second temperature (e.g., high temperature). Accordingly, a capacity for the adsorption may generally increase with decreases in temperature and decrease with increases in temperature.

As discussed in detail below, the gas capture systems include one or more phase change materials (PCMs) configured to help improve the efficiency of the gas capture process, such as by providing thermal control (e.g., cooling) during the gas capture process. The PCMs may include solid-liquid PCMs, solid-solid PCMs, solid-gas PCMs, liquid-gas PCMs, or any combination thereof. In general, the PCMs are configured to absorb heat during a phase transition to provide cooling for the gas capture process. For example, the phase transition may be between solid and liquid phases for solid-liquid PCMs, or the phase transition may be between different solid states for solid-solid PCMs (e.g., different crystalline structures). In certain embodiments, the PCMs may include any suitable transition among or between solid, liquid, and gas phases. The PCMs may be stored or housed in one or more enclosures, such as an interior chamber of a contactor plate, a plurality of micro-encapsulations (e.g., micro capsules), or a combination thereof. In some embodiments, the solid-solid PCMs may form a body and/or wall of a duct, a contactor plate, or another structure along a flow path of the intake air and/or exhaust gas being treated by the gas capture systems.

The PCMs may be suitable for various types and configurations of gas capture systems. For example, the sorbent-based gas capture systems are configured to adsorb the undesirable gases into a sorbent material, and then subsequently desorb the undesirable gases from the sorbent material using a heat source (e.g., steam from the HRSG, steam from the steam turbine system, or other steam source). The adsorption process is exothermic, while the desorption process is endothermic. As discussed in detail below, the sorbent-based gas capture systems include one or more PCMs configured to improve the efficiency of the adsorption process by absorbing heat generated due to the adsorption of undesirable gases into the sorbent materials, thereby helping to maintain a temperature of the sorbent materials below an upper temperature threshold and/or within upper and lower temperature thresholds. In some embodiments, the PCMs are configured to enable an isothermal operating mode of the adsorption process. The adsorption efficiency of the sorbent materials generally decreases with increases in temperature and increases with decreases in temperature. Accordingly, the PCMs improve the efficiency of adsorption by the sorbent materials by maintaining a sufficiently low temperature of the sorbent materials during the adsorption process.

By further example, the solvent-based gas capture systems may include an absorber configured to absorb the undesirable gas into a solvent, and a stripper configured to strip the undesirable gas from the solvent using steam (e.g., steam from the HRSG, steam from the steam turbine system, or other steam source). Although the solvent-based gas capture systems are discussed as using a solvent as an absorbent fluid, the disclosed embodiments may use any suitable absorbent fluid for capturing undesirable gases. Accordingly, the solvent-based gas capture system also may be described as a fluid absorbent-based gas capture system. As the absorption process occurs, heat is generated within the absorber, thereby raising the temperature of the solvent within the absorber. In certain embodiments, the absorber includes the PCMs to control the temperature of the solvent, and improve the efficiency of the absorption process.

As discussed below, the PCMs may be used in a variety of configurations with the gas capture systems. Although specific examples are provide below, the PCMs may be used in any suitable manner to support various gas capture systems, including but not limited to, sorbent-based gas capture systems, solvent-based gas capture systems, and cryogenic gas capture systems.

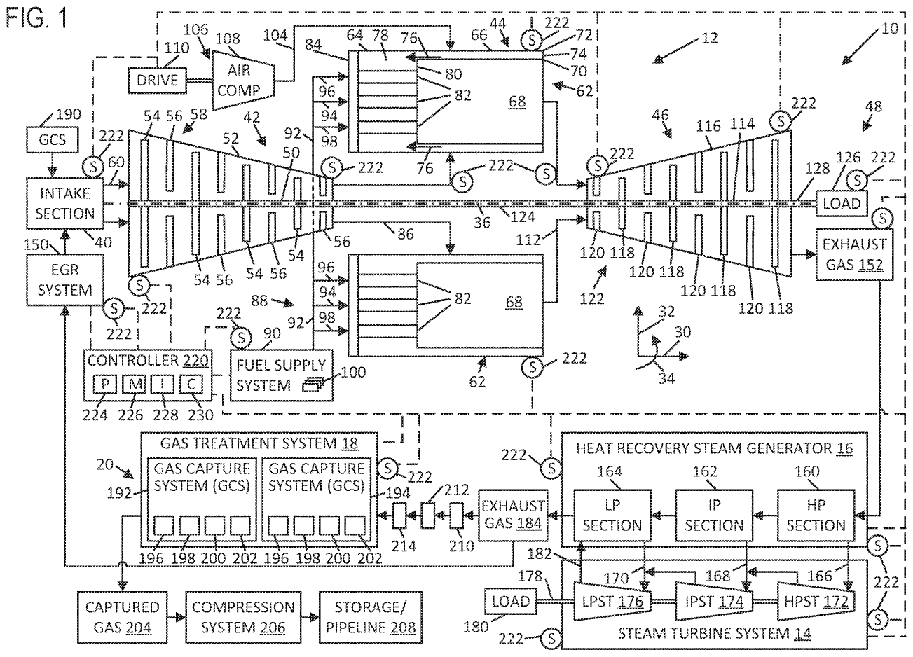

FIG. 1 is a block diagram of an embodiment of a combined cycle system 10 having a gas turbine system 12, a steam turbine system 14, a heat recovery steam generator (HRSG) 16, and a gas treatment system 18. The gas treatment system 18 includes one or more gas capture systems 20 configured to capture an undesirable gas (e.g., CO₂) from a gas, such as exhaust gas and/or air. The gas capture systems 20 may include sorbent-based gas capture systems, solvent-based gas capture systems, cryogenic gas capture systems, or any combination thereof. In certain embodiments, the gas capture systems 20 include one or more phase change materials (PCMs) configured to provide thermal control of the gas capture process. The PCMs may include solid-liquid PCMs, solid-solid PCMs, solid-gas PCMs, liquid-gas PCMs, or any combination thereof.

In certain embodiments, the PCMs are configured to absorb heat generated during the gas capture process (e.g., adsorption of undesirable gases in sorbent material or absorption of undesirable gases in solvent), thereby helping to maintain a temperature of the gas capture system within suitable temperature thresholds (e.g., upper and lower temperature thresholds) to improve the efficiency of the gas capture process. The upper and lower temperature thresholds may define limits based on a desired operating temperature of the gas capture system 20, and thus the upper and lower temperature thresholds may be plus or minus 5, 10, 15, 20, 25, 30, 35, 40, 45, 50, or more degrees Celsius or Fahrenheit around the desired operating temperature. In certain embodiments, the PCMs enable an isothermal operating mode of the gas capture systems 20, wherein the temperature may be maintained constant or substantially constant (e.g., plus or minus 1, 2, 3, 4, or 5 degrees Celsius or Fahrenheit) during absorption or adsorption of the undesirable gases.

Before discussing details of the gas treatment system 18, various aspects of the combined cycle system 10 are discussed in further detail. For purposes of orientation in the drawings, reference may be made to an axial direction or axis 30, a radial direction or axis 32 extending radially away from the axial direction or axis 30, and a circumferential direction or axis 34 extending circumferentially around the axial direction or axis 30. The directions or axes 30, 32, and 34 may be in reference to a rotational axis 36 of the gas turbine system 12, for example.

The gas turbine system 12 may include an intake section 40, a compressor or compressor section 42, a combustor section 44, a gas turbine or turbine section 46, and an exhaust section 48. The compressor section 42 may include at least one shaft 50 disposed along the rotational axis 36, a casing 52 (e.g., annular casing) disposed circumferentially about the at least one shaft 50, a plurality of rotating compressor blades 54 extending radially outward from the at least one shaft 50, and a plurality of stationary compressor vanes 56 extending radially inward from the casing 52 toward the at least one shaft 50. In the illustrated embodiment, the compressor section 42 may include a plurality of compressor stages 58, each having a plurality of the compressor vanes 56 spaced circumferentially about the at least one shaft 50 at an axial position, and a plurality of the compressor blades 54 spaced circumferentially about the at least one shaft 50 at a different axial position (i.e., the compressor vanes 56 and the compressor blades 58 are axially spaced apart). Accordingly, the compressor section 42 is configured to receive a flow of an intake gas 60 from the intake section 40 and to progressively compress the intake gas 60 through the plurality of compressor stages 58. As discussed in further detail below, the intake gas 60 may include an intake air, an exhaust gas recirculation (EGR) flow or recirculated exhaust gas, or a combination thereof.

The combustor section 44 may include one or more combustors 62, such as a single annular combustor disposed circumferentially about the rotational axis 36 or a plurality of combustors 62 circumferentially spaced about the rotational axis 36. In the illustrated embodiment, each combustor 62 includes a head end portion 64 coupled to a combustion portion 66. The combustion portion 66 includes a combustion chamber 68, a combustor liner 70 disposed circumferentially about the combustion chamber 68, a flow sleeve 72 disposed circumferentially about the combustor liner 70, and a passage 74 extending between the combustor liner 70 and the flow sleeve 72. The passage 74 is configured to route a compressed gas flow in an upstream direction 76 toward a head end chamber 78 disposed in the head end portion 64. The head end chamber 78 and the combustion chamber 68 of the combustor 62 are separated or divided from one another by an intermediate plate 80. In the head end chamber 78, a plurality of fuel nozzles 82 are coupled to the intermediate plate 80 and an end plate 84 of the head end portion 64. In operation, each combustor 62 receives a compressed gas 86 (e.g., air, EGR, etc.) from the compressor section 42, routes the compressed gas 86 along the passage 74 toward the head end chamber 78 as indicated by arrow 76, and routes the compressed gas through the fuel nozzles 82 into the combustion chamber 68.

In certain embodiments, each combustor 62 may receive one or more fuel flows from a fuel system 88 coupled to the fuel nozzles 82, wherein the fuel system 88 includes a fuel supply system 90 coupled to one or more fuel circuits 92. For example, the fuel circuits 92 may include fuel circuits 94, 96, and 98 coupled to different sets of the fuel nozzles 82. The fuel circuits 92 (e.g., 94, 96, and 98) may include fuel conduits, fuel manifolds, fuel valves, pressure regulators, and other flow controls. The fuel system 88 is configured to supply one or more fuels, such as liquid and/or gas fuels, into each of the fuel nozzles 82 for injection into the combustion chamber 68. The fuels may include natural gas, syngas generated from a gasifier, methane, hydrogen, biofuel, fuel oils, or any combination thereof. The fuel supply system 90 may include a plurality of components to control flows of the various fluids to the combustor 62. For example, the fuel supply system 90 may include one or more components 100. In certain embodiments, the components 100 may include one or more fuel tanks, fuel pumps, valves, pressure regulators, flow regulators, filters, water removal units, particulate removal units, manifolds, flow controllers, or any combination thereof.

The fuel nozzles 82 are configured to inject one or more fuels from the fuel system 88 and the compressed gas 86 from the compressor section 42. In certain embodiments, the fuel nozzles 82 are configured to inject a compressed air 104 from a compressor system 106 having an air compressor 108 coupled to a drive 110, such as an electric motor, a combustion engine, a shaft coupled to the gas turbine system 12, or another suitable drive. The compressor system 106 may be configured to receive air from ambient and/or from the intake section 40. Additionally, the compressor system 106 may be configured to enable multiple modes of operation, such as EGR mode or non-EGR mode. For example, in certain embodiments of the gas turbine system 12 having exhaust gas recirculation (EGR), the compressor section 42 supplies the compressed gas 86 (e.g., compressed exhaust gas) to each combustor 62, while the compressor system 106 supplies the compressed air 104 to each combustor 62.

By further example, in certain embodiments of the gas turbine system 12 without exhaust gas recirculation (EGR), the compressor section 42 supplies the compressed gas 86 (e.g., compressed air) to each combustor 62 without any need for additional air supplies. Thus, the compressor system 106 may optionally supply the compressed air 104 to each combustor 62. In operation, the fuel may be combusted with the air in the combustion chamber 68 of each combustor 62, thereby generating a hot combustion gas 112 for delivery from the combustion chamber 68 into the turbine section 46.

The turbine section 46 includes at least one shaft 114 disposed along the rotational axis 36, a casing 116 (e.g., annular casing) disposed circumferentially about the at least one shaft 114, a plurality of rotating turbine blades 118 extending radially outward from the at least one shaft 114, and a plurality of stationary turbine vanes 120 extending radially inward from the casing 116 toward the at least one shaft 114. The turbine section 46 may include a plurality of turbine stages 122, each having a plurality of the turbine vanes 120 spaced circumferentially about the at least one shaft 114 at an axial position, and a plurality of the turbine blades 118 spaced circumferentially about the at least one shaft 114 at a different axial position (i.e., the turbine vanes 120 and the turbine blades 118 are axially spaced apart). The at least one shaft 114 also may be coupled to the at least one shaft 50 of the compressor section 42 via at least one intermediate shaft 124. Additionally, the at least one shaft 114 may be coupled to a load 126 via a shaft 128. In certain embodiments, the load 126 may include an electrical generator, a machine, a propulsion system for a vehicle, or any other suitable load. In the illustrated embodiment, the load 126 may be an electrical generator, such that the combined cycle system 10 is a combined cycle power plant. In operation, the combustion gas 112 flows from the combustor 62 into the turbine section 46, wherein the combustion gas 112 progressively expands and drives rotation of the turbine blades 118 coupled to the at least one shaft 114 in each of the turbine stages 122. Thus, the combustion gas 112 drives the turbine section 46, which in turn drives the compressor section 42 and the load 126 via the interconnected shafts 50, 124, 114, and 128.

In certain embodiments, the gas turbine system 12 may be configured with a common rotational direction of the shafts 50, 114, 124, and 128 and the connected compressor blades 54 and turbine blades 118. The shafts 50, 114, 124, and 128 may be removably coupled together with shaft connections, such as flanged joints. In some embodiments, some of the shafts may be combined to reduce the number of shafts. For example, all of the illustrated shafts 50, 114 and 124 may represent a common shaft rotating in the common rotational direction, such as a clockwise or counter-clockwise rotational direction.

The gas turbine system 12 can be configured with or without the compressor system 106 and an exhaust gas recirculation (EGR) system 150. The EGR system 150 is configured to recirculate an exhaust gas 152 output by the turbine section 46 back into the compressor section 42 (e.g., via intake section 40) for compression and delivery to the combustor section 44. However, the gas turbine system 12 may exclude the EGR system 150 and intake only an airflow into the intake section 40 for compression by the compressor section 42.

In certain embodiments of the gas turbine system 12 having the EGR system 150, the recirculated exhaust gas 152 flows through the intake section 40 and each of the compressor stages 58 of the compressor section 42, thereby compressing the recirculated exhaust gas as the compressed gas 86 for delivery into combustor section 44. Additionally, the combustor section 44 may receive compressed air 104 from the air compressor 108 of the compressor system 106 through the fuel nozzles 82. The combustor section 44 also receives the fuel from the fuel system 88, such as through the fuel nozzles 82. The fuel from the fuel system 88 then combusts with the air from the compressor system 106 to generate the combustion gases 112, which then flow through the turbine section 46 to drive rotation of the turbine blades 118 in each of the turbine stages 122. The recirculated exhaust gas helps to reduce the temperature and formation of certain emissions (e.g., nitrogen oxides (NOx)) associated with combustion in the combustor section 44.

In certain embodiments of the gas turbine system 12 without the EGR system 150, the compressor section 42 receives an airflow from the intake section 40, progressively compresses the airflow via the compressor stages 58, and delivers the compressed airflow as the compressed gas 86 into the combustor section 44. The compressed airflow then facilitates combustion of the fuel from the fuel system 88, thereby generating the hot combustion gases 112 for delivery to the turbine section 46. In such embodiments, the compressor system 106 may be excluded or included to provide additional compressed air 104 to the combustor section 44. Regardless of the configuration, the combustion gas 112 drives rotation of the turbine blades 118 in the turbine stages 122, thereby rotating the at least one shaft 114 coupled to the at least one shaft 50 of the compressor section 42 and the shaft 128 driving the load 126.

The exhaust gas 152 output by the turbine section 46 may then pass through the HRSG 16 for transfer of heat from the exhaust gas into water to generate steam for the steam turbine system 14. For example, the HRSG 16 may include a high-pressure section 160, an intermediate-pressure section 162, and a low-pressure section 164 in a series arrangement, thereby generating a high-pressure steam 166, an intermediate-pressure steam 168 and a low-pressure steam 170. The heat recovery steam generator 16 may route the high-pressure steam 166 to a high-pressure steam turbine 172, the intermediate-pressure steam 168 to an intermediate-pressure steam turbine 174, and the low-pressure steam 170 to a low-pressure steam turbine 176 of the steam turbine system 14. The steam drives rotation of blades within each of the steam turbines 172, 174, 176, thereby driving a shaft 178 coupled to a load 180, such as an electric generator. The low-pressure steam turbine 176 also may return a condensate 182 back to the low-pressure section 164 of the HRSG 16. The HRSG 16 may then output the exhaust gas 152 as a partially cooled exhaust gas 184, which may then pass through the gas treatment system 18.

As discussed above, the gas treatment system 18 includes one or more gas capture systems 20. For example, the gas capture systems 20 may include any one or any combination of gas capture systems 190, 192, and 194, each having a plurality of components (e.g., components 196, 198, 200, and 202). The gas capture systems 20 (e.g., 190, 192, and 194) are configured to obtain a captured gas 204 from the intake gas 60 and/or the exhaust gas 152, 184. In the illustrated embodiment, the gas capture systems 20 (e.g., 190, 192, and 194) may capture and output carbon dioxide (CO₂) as the captured gas 204, which may further be directed to a compression system 206. For example, the compression system 206 may include one or more compressors configured to compress the captured gas 204 (e.g., CO₂) and deliver the captured gas to storage and/or a pipeline 208.

The gas capture system 190 is disposed at, in, or upstream of the intake section 40 for capturing undesirable gases from the intake air. The gas capture systems 192 and 194 are disposed downstream of the gas turbine system 12 and/or the HRSG 16 for capturing undesirable gases from the exhaust gas 152, 184. The gas capture systems 20 (e.g., 190, 192, and 194) may include sorbent-based gas capture systems, solvent-based gas capture systems, cryogenic gas capture systems, or any combination thereof, configured to remove and capture undesirable gases. In certain embodiments, the gas capture systems 20 (e.g., 190, 192, and 194) may be configured to remove and capture undesirable gases, such as carbon oxides (COx) (e.g., carbon dioxide (CO₂) and carbon monoxide (CO)), and thus the gas capture systems 20 may be described as carbon capture systems. In certain embodiments, the gas capture systems 20 (e.g., 190, 192, and 194) may be configured to remove and capture undesirable gases, such as nitrogen oxides (NOx) (e.g., nitrogen dioxide (NO₂)), and thus the gas capture systems 20 may be described as NOx capture systems. In certain embodiments, the gas capture systems 20 (e.g., 190, 192, and 194) may be configured to remove and capture undesirable gases, such as sulfur oxides (SOx) (e.g., sulfur dioxide (SO₂)), and thus the gas capture systems 20 may be described as SOx capture systems. In the following discussion, the gas capture systems 20 (e.g., 190, 192, and 194) may be described as sorbent-based carbon capture systems using sorbent materials as an example and/or solvent based carbon capture systems using liquid absorbents (e.g., solvents) as an example. However, the embodiments disclosed herein may use any type or configuration of gas capture systems 20 (e.g., 190, 192, and 194) as noted above.

Each of the gas capture systems 20 (e.g., 190, 192, and 194) may include components 196, 198, 200, and 202. Additionally, one or more components 210, 212, and 214 may be disposed upstream from the gas capture systems 192 and 194. For sorbent-based gas capture systems 20 (e.g., 190, 192, and 194), the components 196, 198, 200, and 202 may include sorbent materials disposed on or in ducts (e.g., adsorption duct, desorption duct, and cooling duct), contactors, cartridges, moving beds, rotating wheels, cartridges, or any combination thereof, along a flow path of the intake gas 60 and/or the exhaust gas 152, 184. The sorbent-based gas capture systems 20 are configured to adsorb the undesirable gases (e.g., CO₂) into the sorbent materials in an adsorption mode and desorb the undesirable gases from the sorbent materials in a desorption mode. The components 196, 198, 200, and 202 may include PCMs configured to absorb heat generated by the adsorption mode to help control the temperature of the sorbent materials (e.g., maintain sorbent temperatures within upper and lower temperature thresholds) to improve efficiency of the adsorption mode. The components 196, 198, 200, and 202 may also include a cooling system, such as heat exchangers (e.g., fin and tube heat exchangers), heat pipes, and other thermal control systems, coupled to the sorbent materials to help control the temperature of the sorbent materials in combination with the PCMs. The components 196, 198, 200, and 202 also may include heating systems, such as heated fluid systems (e.g., steam systems, electrical heaters, waste heat systems, etc.), configured to apply heat to the sorbent materials to desorb the undesirable gases from the sorbent materials during the desorption mode. The PCMs also may absorb heat during the desorption mode. The components 196, 198, 200, and 202 also may include cooling systems, such as cooling fluid systems (e.g., gas cooling systems, liquid cooling systems, etc.), configured to apply a cooling fluid to the sorbent materials and the PCMs during a cooling mode. Accordingly, the PCMs may release heat during the cooling mode, thereby regenerating the PCMs and/or changing a phase of the PCMs in preparation of the next adsorption mode. The sorbent-based gas capture systems 20 also may include other suitable components 196, 198, 200, and 202 in support of the sorbent materials.

For solvent-based gas capture systems 20 (e.g., 190, 192, and 194), the components 196, 198, 200, and 202 may include one or more absorbers, one or more strippers, and a solvent circuit through the absorbers and strippers. The absorber is configured to absorb the undesirable gases (e.g., CO₂) into a solvent in an absorption mode, thereby outputting a treated gas (e.g., treated air or treated exhaust gas) and a gas-rich solvent (e.g., CO₂ rich solvent). The stripper is configured to strip the undesirable gases from the gas-rich solvent in a desorption mode, thereby outputting a gas-lean solvent (e.g., CO₂ lean solvent) back to the absorber and outputting the captured gas 204. The components 196, 198, 200, and 202 may include PCMs coupled to the absorber, wherein the PCMs are configured to absorb heat generated by the absorption mode to help control the temperature of the solvent (e.g., maintain solvent temperatures within upper and lower temperature thresholds) to improve efficiency of the absorption mode. The components 196, 198, 200, and 202 may also include one or more cooling systems, such as heat exchangers (e.g., fin and tube heat exchangers), heat pipes, and other thermal control systems, coupled to the absorber to help control the temperature of the solvent in combination with the PCMs. In certain embodiments, the cooling systems may be arranged with a plurality of cooling circuits, each having PCMs, heat exchangers, heat pipes, or other coolers, wherein the gas capture systems 20 may selectively use each of the cooling circuits in different modes (e.g., a cooling mode for cooling the solvent by absorbing heat into the PCMs or a regeneration mode for cooling the PCMs). The components 196, 198, 200, and 202 also may include heating systems, such as heated fluid systems (e.g., steam systems, electrical heaters, waste heat systems, etc.), coupled to the strippers, wherein the heating systems are configured to apply heat to the gas-rich solvent to desorb the undesirable gases from the gas-rich solvent during the desorption mode. The components 196, 198, 200, and 202 also may include a reboiler coupled to the stripper, pumps and valves to control a flow of the solvent through the solvent circuit between the absorber and the stripper, and heat exchangers to cool the gas-lean solvent supplied to the absorber and to heat the gas-rich solvent supplied to the stripper. The solvent-based gas capture systems 20 also may include other suitable components 196, 198, 200, and 202 in support of the absorbers and strippers.

In certain embodiments, the components 196, 198, 200, and 202 of the gas capture system 20 and/or the components 210, 212, and 214 upstream from the gas capture systems 192 and 194 may include one or more of a dryer or water removal system (e.g., water gas separator), a particulate removal system (e.g., filter and/or solid gas separator), one or more booster fans configured to boost a flow of the gas being treated, one or more coolers, one or more valves to control a flow of gas to the gas capture system 20, a bypass system configured to bypass the gas capture system 20, or any combination thereof. The cooler may include a heat exchanger, a direct contact cooler (DCC), or a combination thereof. The heat exchanger is configured to indirectly cool the exhaust gas 184 via heat exchange between the exhaust gas 184 and a cooling fluid (e.g., cooling water). The direct contact cooler is configured to directly cool the exhaust gas 184 via direct injection of a cooling fluid (e.g., cooling water) into the exhaust gas 184. Thus, the cooler is configured to cool the exhaust gas 184 prior to treatment in the gas treatment system 18. The separators may include gravity separators, centrifugal separators, or a combination thereof. In some embodiments, the gas capture systems 20 (e.g., 190, 192, and 194) may be described as multiple gas capture stages. However, in some embodiments, the gas treatment system 18 may include only a single stage and/or gas capture system 20. For example, the gas capture systems 20 may include only one, two, or all three of the gas capture systems 190, 192, and/or 194.

In certain embodiments, the exhaust gas 184 may partially or entirely bypass the gas treatment system 18 and flow to the EGR system 150, and/or the exhaust gas 184 may partially or entirely flow through the gas treatment system 18 before flowing to the EGR system 150. The EGR system 150 may include one or more conduits, valves, flow controls, coolers, blowers, or any combination thereof, configured to provide at least a portion of the exhaust gas 152, 184 (e.g., EGR flow) to the intake section 40 for recirculation through the compressor section 42. The cooler may be configured to cool the exhaust gas 152, 184 to a lower temperature (e.g., approximately ambient temperature) prior to recirculation into the compressor section 42. The blower may be configured to increase a pressure and flow of the exhaust gas 152, 184 to help overcome pressure losses in the EGR system 150.

In the illustrated embodiment, the combined cycle system 10 also includes a controller 220 coupled to the gas turbine system 12, the steam turbine system 14, the HRSG 16, the gas treatment system 18, the fuel system 88, the EGR system 150, the compression system 106, and various sensors 222 distributed throughout the combined cycle system 10. In the illustrated embodiment, the controller 220 includes one or more processors 224, memory 226, instructions 228 stored on the memory 226 and executable by the processor 224, and communication circuitry 230 configured to communicate with the sensors 222 and various equipment throughout the combined cycle system 10. For example, the controller 220 is configured to control the fuel delivery and distribution from the fuel system 88 to the fuel nozzles 82 in the combustor section 44. In certain embodiments, the controller 220 is configured to control operation of the gas capture systems 20 (e.g., 190, 192, and 194), such by controlling modes of operation (e.g., adsorption mode, desorption mode, cooling mode), controlling cooling of the PCMs, controlling flows of various fluids through the gas capture systems 20, or any combination thereof.

The sensors 222 (designated with an “S”) are configured to monitor various operational parameters of the combined cycle system 10. In certain embodiments, the sensors 222 include temperature sensors, pressure sensors, flow rate sensors, fluid composition sensors (e.g., gas composition sensors), vibration sensors, clearance sensors, speed sensors, humidity and/or moisture sensors, or any combination thereof. The sensors 222 may monitor the parameters (e.g., temperature, pressure, flow rate, and fluid composition) at one or more locations of the compressor section 42, the combustor section 44, the turbine section 46, the gas treatment system 18, or any combination thereof.

For example, the sensors 222 may monitor compressor parameters (e.g., pressure ratio between the inlet and outlet of the compressor section 42), combustion gas parameters (e.g., firing temperature and combustion dynamics), turbine parameters (e.g., temperature and pressure at each turbine stage, the turbine inlet, and the turbine exhaust), and exhaust gas emissions. By further example, the exhaust gas emissions monitored by the sensors 222 may include carbon oxides (COx) such as carbon dioxide (CO₂) and carbon monoxide (CO), nitrogen oxides (NOx) such as nitrogen dioxide (NO₂), sulfur oxides (SOx) such as sulfur dioxide (SO₂), unburnt hydrocarbons, particulate matter, and other undesirable exhaust emissions. By further example, the sensors 222 may monitor the temperature of the PCMs in the gas capture systems 20, the temperature of the sorbent materials in sorbent-based gas capture systems, the temperature of solvent in solvent-based gas capture systems, or any combination thereof. In response to the feedback from the sensors 222, the controller 220 may adjust the operating mode, fluid flows, heating, cooling, or any combination thereof, in the gas capture systems 20.

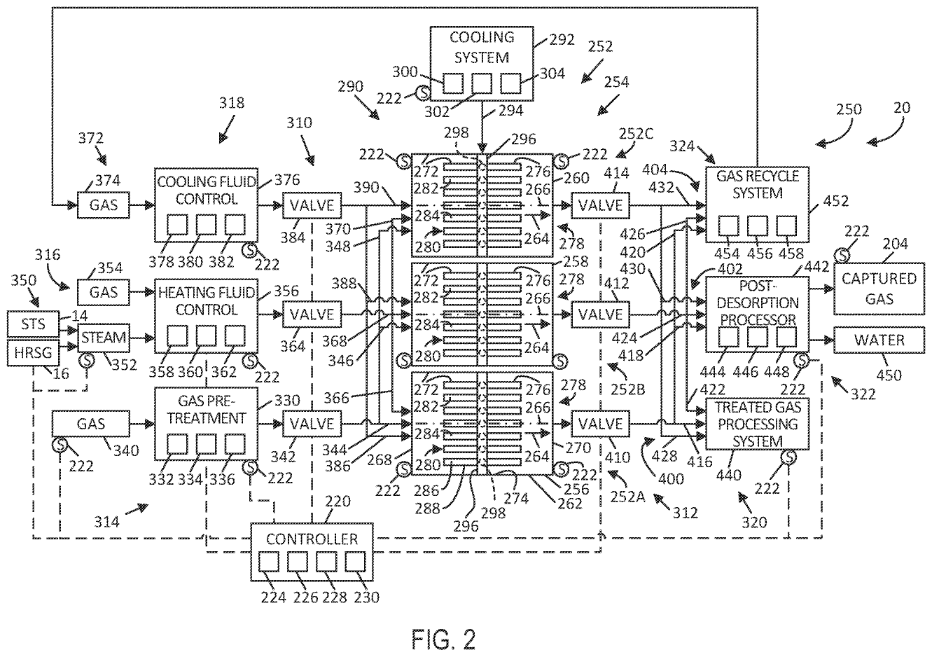

FIG. 2 is a schematic of an embodiment of a gas capture system 20 of the gas treatment system 18 of FIG. 1, illustrating a sorbent-based gas capture system 250. In the illustrated embodiment, the sorbent-based gas capture system 250 includes a plurality of sorbent-based gas capture assemblies or units 252 (e.g., adsorbers or adsorption units) associated with a plurality of respective conduits 254, such as conduits 256, 258, and 260 (e.g., sorbent-containing conduits). The sorbent-based gas capture units 252 may include temperature swing adsorption (TSA) units or adsorbers, wherein a temperature swing or change is used to alternatively operate in an adsorption mode at a first temperature and a desorption mode at a second temperature. The first temperature is lower than the second temperature. The lower first temperature enables the sorbent-based gas capture units 252 to adsorb the undesirable gas, where lower temperatures generally increase a capacity for adsorbing the undesirable gas. The higher second temperature enables the sorbent-based gas capture units 252 to desorb the undesirable gas, which can then be captured and used in other downstream processes.

In the illustrated embodiment, the sorbent-based gas capture units 252 include sorbent-based gas capture units 252A, 252B, and 252C associated with the conduits 256, 258, and 260. The conduits 254 (e.g., 256, 258, and 260) may be sorbent-lined along interior surfaces, sorbent-packed within interior volumes, or generally filled with at least 10, 20, 30, 40, 50, 60, 70, 80, 90, or more percent by volume of sorbent material. However, the sorbent-based gas capture unit 252 may include any number of conduits 254, such as 2, 3, 4, 5, 6, 7, 8, 9, 10, or more, which are configured in parallel and/or series. Each of the conduits 254 (e.g., 256, 258, and 260) includes an outer conduit wall 262 disposed circumferentially about a flow path 264 (e.g., fluid passage or bore) along a central axis 266 from an inlet 268 to an outlet 270, wherein a sorbent material 272 is disposed along an interior surface 274 of the outer conduit wall 262 and/or along an exterior surface 276 of a plurality of contactors 280 (e.g., contactor plates, panels, or fins). In the illustrated embodiment, the contactors 280 are arranged parallel to one another and parallel to the central axis 266. Each of the conduits 254 (e.g., 256, 258, and 260) may include a contactor assembly 278 having any number of the contactors 280, such as 1, 2, 3, 4, 5, 6, 7, 8, 9, 10, or more contactors 280.

As discussed in further detail below, the sorbent material 272 may be disposed over a PCM 282, such as a solid-liquid PCM, a solid-solid PCM, a solid-gas PCM, a liquid-gas PCM, or any combination thereof. For example, the PCM 282 may be a solid-solid PCM forming one or more layers under the sorbent material 272 along the interior surface 274 of the outer conduit wall 262 and/or the exterior surface 276 of the contactors 280, a solid-solid PCM forming at least part or all of the outer conduit wall 262, and/or a solid-solid PCM forming at least part or all of the contactors 280 (e.g., body, framework, wall, etc.). By further example, the PCM 282 may be a solid-liquid PCM, a solid-solid PCM, a solid-gas PCM, a liquid-gas PCM, or any combination thereof, disposed inside of a container or enclosure along the outer conduit wall 262 and/or the contactors 280. Each of the contactors 280 has a body 284 with the exterior surface 276 disposed about an interior portion 286. In certain embodiments, the body 284 may be a solid body throughout the interior portion 286, wherein the body 284 is at least substantially or completely made with the solid-solid PCM throughout the interior portion 286 to the exterior surface 276. In some embodiments, the body 284 may be a hollow body throughout the interior portion 286 (e.g., interior chamber or cavity), wherein the body 284 has an outer wall 288 disposed about the interior portion 286, and the interior portion 286 is at least partially or entirely filled with the PCM 282. For example, the outer wall 288 may define a sealed enclosure or housing, which completely contains the PCM 282 within the interior portion 286. The PCM 282 inside the outer wall 288 may include a solid-liquid PCM, a solid-solid PCM, a solid-gas PCM, a liquid-gas PCM, or any combination thereof.

The PCM 282 is configured to control or regulate a temperature of the sorbent material 272 during an adsorption mode of the gas capture system 20, such as by absorbing heat due to the adsorption of undesirable gases (e.g., CO₂) into the sorbent material 272 to help maintain a desired operating temperature of the sorbent material 272 within a suitable temperature range (e.g., within upper and lower temperature thresholds) to increase the adsorption efficiency of the sorbent material 272. In certain embodiments, the upper and lower temperature thresholds may be plus or minus 5, 10, 15, 20, 25, 30, 35, 40, 45, 50, or more degrees Celsius or Fahrenheit around the desired operating temperature of the sorbent material 272. For example, the PCM 282 may be configured to absorb and store heat by undergoing a phase change at phase change temperatures between −56.6 to 100, 10 to 100, 15 to 80, 20 to 70, or 25 to 65 degrees Celsius. By further example, the PCM 282 may be configured to absorb and store heat by undergoing a phase change at phase change temperatures between about ambient temperatures and 75 degrees Celsius. By further example, the PCM 282 may be configured to absorb and store heat by undergoing a phase change at phase change temperatures of less than or equal to 25, 30, 35, 40, 45, 50, 55, 60, 65, 70, 75, 100, 125, 150, 175, or 200 degrees Celsius. As an example, a solid-solid PCM 282 may change crystalline structure from one lattice configuration to another in an operating temperature range of 50 to 175 degrees Celsius. As another example, a polyurethane PCM 282 may have an operating temperature range of 20 to 36 degrees Celsius. The operating temperature ranges may vary for other solid-solid PCMs 282, such as polymer PCMs, and various solid-liquid PCMs 282, such as paraffins, inorganic salt hydrates (Na₂SO₄.10H₂O), bio-PCMs (e.g., organic fatty acid ester PCMs made from natural resources, such as soy beans and palm oils), and sodium acetate trihydrate (SAT, C₂H₉NaO₅). In certain embodiments, the PCM 282 enables an isothermal operating mode of the sorbent-based gas capture system 250 (e.g., sorbent material 272 of the sorbent-based gas capture units 252), wherein the temperature may be maintained constant or substantially constant (e.g., plus or minus 1, 2, 3, 4, or 5 degrees Celsius or Fahrenheit) during adsorption of the undesirable gases in the sorbent material 272.

The temperature of the sorbent material 272 directly affects the adsorption efficiency of the sorbent material 272 during the adsorption mode. The sorbent material 272 may have an optimal temperature or temperature range for efficient adsorption of the undesirable gases. Unfortunately, the adsorption of the undesirable gases into the sorbent material 272 is an exothermic process, which generates heat that generally increases the temperature of the sorbent material 272 and reduces its adsorption efficiency without any cooling of the sorbent material 272. The PCM 282 absorbs the heat associated with the adsorption process, because the PCM 282 uses the heat for transitioning between different phases. As discussed in detail below, the gas capture system 20 is configured to sequentially and repeatedly operate in a cycle of: (1) an adsorption mode, (2) a desorption mode, and (3) a cooling mode for each of the sorbent-based gas capture units 252A, 252B, and 252C. The PCM 282 generally absorbs heat during the adsorption and desorption modes, whereas the PCM 282 releases heat during the cooling mode. In particular, the cooling mode is used to cool and regenerate the PCM 282 for a subsequent cycle starting with the adsorption mode. Accordingly, the cooling mode is configured to cool the PCM 282 and cause a phase change in preparation of the next adsorption mode.

The temperatures in the adsorption mode, the desorption mode, and the cooling mode may vary depending on the particular application. In certain embodiments of carbon capture (e.g., CO₂ capture), the adsorption mode may be configured to adsorb undesirable gas from a gas 340 at a first temperature, the desorption mode may be configured to desorb the undesirable gas using a heat source (e.g., heated fluid) at a second temperature, and the cooling mode may be configured to cool the PCM 282 using a cooling source (e.g., cooling fluid) at a third temperature, wherein the second temperature is greater than the first and third temperatures, and the third temperature is lesser than the first and third temperatures. For example, the first temperature may be approximately 40 degrees Celsius (e.g., plus or minus 5, 10, 15, or 20 degrees Celsius), the second temperature may be equal to or greater than approximately 100, 110, 120, 130, 140, or 150 degrees Celsius, and the third temperature may be less than or equal to approximately 0, 5, 10, 15, 20, 25, or 30 degrees Celsius.

In the illustrated embodiment, the gas capture system 20 includes a thermal control system 290 having a cooling system 292, one or more cooling circuits 294 (e.g., fluid conduits, manifolds, valves, etc.), and one or more heat exchangers 296 coupled to each contactor assembly 278 in the sorbent-based gas capture units 252A, 252B, and 252C. The heat exchangers 296 may include one or more heat exchange flow paths coupled to and/or extending through each contactor assembly 278. The heat exchangers 296 also may include a plurality of heat pipes 298, wherein each contactor assembly 278 includes one or more heat pipes 298 coupled to and/or extending through each contactor 280 in the contactor assembly 278. The cooling system 292 may include a plurality of components, such as components 300, 302, and 304, such as heat exchangers, pumps, valves, coolant supplies, or any combination thereof. The thermal control system 290 may circulate a coolant or cooling fluid (e.g., liquid or gas coolant) from the cooling system 292 through the cooling circuits 294 and the heat exchangers 296 to cool the contactors 280, the sorbent materials 272, and the PCMs 282 during any one or all of the operating modes (e.g., adsorption mode, desorption mode, and/or cooling mode). In certain embodiments, the cooling circuits 294 may include independent cooling circuits for each of the contactor assemblies 278, such that the thermal control system 290 can independently control the temperature for each of the contactor assemblies 278 depending on the operating modes (e.g., adsorption mode, desorption mode, and/or cooling mode) of the sorbent-based gas capture units 252A, 252B, and 252C. In some embodiments, the thermal control system 290 is configured to provide cooling during the cooling mode, thereby cooling the PCMs 282 to facilitate a regeneration or phase change of the PCMs 282 in preparation of a subsequent absorption mode.

The sorbent material 272 (e.g., solid adsorbents) may cover, coat, or generally line at least 50, 60, 70, 80, 90, 95, or 100 percent of the interior surface 274 of the outer conduit wall 262, the exterior surface 276 of the contactors 280, and/or other structures within the conduits 254. In some embodiments, the contactors 280 may include rectangular plates, airfoil shaped panels, a parallel arrangement of tubes, a grid arrangement of tubes, a plurality of cartridges, radial projections, baffles, fins, honey comb structures, a plurality of contactor elements supported in a bundle, or any combination thereof. The plurality of contactor elements may include a plurality of particles, beads, strips, strands, mesh, or other distributed structures, which leave voids for fluid flow. Additionally or alternatively, the sorbent material 272 may at least partially fill or pack an interior volume of the central bore or interior surface 274, such that voids remain to facilitate fluid flow (e.g., a void fraction of less than or equal to 10, 20, 30, 40, or 50 percent). Furthermore, in some embodiments, the central axis 266 extending from the inlet 268 to the outlet 270 may define the flow path 264 as a linear flow path, a curved flow path, a winding or serpentine flow path, a spiral or helical flow path, a tortuous flow path, an expanding and contracting flow path, a flow path with splits and/or unions, or any combination thereof. For example, the flow path 264 may be defined as a tortuous flow path and include any number or configuration of the foregoing flow paths.

The sorbent material 272 may include one or more sorbent materials configured to adsorb the undesirable gases, such as sorbent materials designed or suitable for adsorption of carbon oxides (COx) such as carbon dioxide (CO₂) and carbon monoxide (CO), nitrogen oxides (NOx), sulfur oxides (SOx) such as sulfur dioxide (SO₂), methane (CH₄), or any other undesirable gases as described herein or subject to regulations and/or considered greenhouse gases. For example, the sorbent materials 272 may include porous, solid-phase materials, including mesoporous silicas, zeolites (e.g., aluminosilicates), and metal-organic frameworks (MOFs) and covalent organic frameworks (COFs). The foregoing sorbent materials 272 may be particularly well-suited for CO₂ adsorption in the sorbent-based gas capture unit 252. However, any suitable sorbent materials 272 may be used depending on the desired target for gas capture of undesirable gases. In certain embodiments, a plurality of the sorbent-based gas capture systems 250 may be used in series, wherein each of the sorbent-based gas capture system 250 uses the same or different sorbent materials 272 to remove and capture the same or different undesirable gases in stages.

The sorbent-based gas capture system 250 may be configured to alternate each of the sorbent-based gas capture units 252A, 252B, and 252C associated with the conduits 256, 258, and 260 between the adsorption mode (e.g., adsorbing the undesirable gases into the sorbent material 272), the desorption mode (e.g., desorbing the undesirable gases from the sorbent material 272), and the cooling mode (e.g., cooling the sorbent material 272 and the PCM 282) using the controller 220 and the sensors 222. The controller 220 is configured to control the sorbent-based gas capture system 250 to perform a staggered operational cycle of the sorbent-based gas capture units 252A, 252B, and 252C between the different operating modes (e.g., adsorption mode, desorption mode, and cooling mode). For example, for a first duration of time, the controller 220 may operate the sorbent-based gas capture unit 252A in the adsorption mode, the sorbent-based gas capture unit 252B in the desorption mode, and the sorbent-based gas capture unit 252C in the cooling mode. By further example, for a second duration of time, the controller 220 may operate the sorbent-based gas capture unit 252A in the desorption mode, the sorbent-based gas capture unit 252B in the cooling mode, and the sorbent-based gas capture unit 252C in the adsorption mode. By further example, for a third duration of time, the controller 220 may operate the sorbent-based gas capture unit 252A in the cooling mode, the sorbent-based gas capture unit 252B in the adsorption mode, and the sorbent-based gas capture unit 252C in the desorption mode. The sorbent-based gas capture system 250 also may be configured to simultaneously operate multiple units (e.g., 2, 3, 4, or more) of the sorbent-based gas capture units 252 in each of the operating modes, such as multiple units 252 in the adsorption mode, multiple units 252 in the desorption mode, and multiple units 252 in the cooling mode. The multiple units 252 may be arranged in series, in parallel, or a combination thereof. The controller 220 is configured to alternate the sorbent-based gas capture units 252 (e.g., 252A, 252B, and 252C) between the adsorption, desorption, and the cooling modes via a plurality of support systems.

The support systems may include the thermal control system 290, an upstream flow distribution system 310, and a downstream flow distribution system 312. The upstream flow distribution system 310 includes a gas supply system 314 (or gas intake system), a heating fluid supply system 316 (e.g., steam and/or heated water supply system), and a cooling fluid supply system 318, while the downstream flow distribution system 312 includes a post-adsorption processing system 320 (e.g., after the adsorption mode), a post-desorption processing system 322 (e.g., gas, steam, and/or heated water processing system after the desorption mode), and a post-cooling system 324 (e.g., after the cooling mode).

The gas supply system 314 of the upstream flow distribution system 310 is configured to provide a gas 340 (e.g., intake gas 60 or exhaust gas 152, 184) to enable the adsorption mode when selectively operating each of the sorbent-based gas capture units 252 (e.g., 252A, 252B, and 252C) in the adsorption mode via the controller 220. The gas supply system 314 includes a gas pre-treatment system 330 having one or more gas pre-treatment components 332, 334, and 336, which may be configured to process, adjust, and/or control characteristics of the gas 340 upstream from the conduits 254 (e.g., 256, 258, and 260) of the sorbent-based gas capture units 252 (e.g., units 252A, 252B, and 252C). For example, the gas pre-treatment component 332 may include a thermal control component (e.g., gas temperature control component), such as a heat exchanger, a heater, a cooler, or any combination thereof, configured to adjust (e.g., increase or decrease) a temperature of the gas 340. The heat exchanger may exchange heat with water, exhaust gas, compressor bleed flow, waste heat, or some other thermal fluid. In some embodiments, a waste heat recovery system may be used for heat transfer in the heat exchanger. The gas pre-treatment component 334 may include a pressure control component, such as a pressure regulator, an expander or expansion chamber, a constrictor or constriction chamber, a fan or pump to add energy, a turbine to extract energy, or another suitable pressure controller. The gas pre-treatment component 336 may include one or more contaminant removal units, such as a particulate filter, a moisture removal unit or dryer, a chemical removal unit, and/or other removal units configured clean the gas 340. For example, the gas pre-treatment component 336 may include a humidity controller configured to maintain a desired relative humidity of the gas 340 being received into the sorbent-based gas capture system 250.

The gas supply system 314 also may include one or more valves 342 configured to control the distribution of the gas 340 to the plurality of conduits 254 (e.g., 256, 258, and 260) of the sorbent-based gas capture units 252 (e.g., 252A, 252B, and 252C) via distribution conduits 344, 346, and 348. For example, the valves 342 may include one or more multi-way valves and/or distribution manifolds to independently distribute the gas 340 through the distribution conduits 344, 346, and/or 348 to the respective sorbent-based gas capture units 252 (e.g., 252A, 252B, and 252C) when operating in an adsorption mode in response to control signals from the controller 220.

The heating fluid supply system 316 of the upstream flow distribution system 310 is configured to supply a heating fluid to enable the desorption mode when selectively operating each of the sorbent-based gas capture units 252 (e.g., 252A, 252B, and 252C) in the desorption mode via the controller 220. As discussed in further detail below, the heating fluid supply system 316 also may coordinate with a vacuum system of the post-desorption processor 442. The heating fluid supply system 316 includes one or more heating fluid supplies 350, such as one or more steam supplies, heated water supplies, heated gas supplies, and/or waste heat supplies. The heating fluids also may be described as sweep fluids, such as a sweep gas or a sweep steam. For example, the heating fluid supplies 350 may include the steam turbine system 14, the HRSG 16, a waste heat recovery system (e.g., recovering heat from compressors, pumps, generators, reactors, or other power plant equipment), a steam generator or boiler, or any combination thereof. The heating fluid supplies 350 may be configured to supply a heating fluid 352 (e.g., steam and/or heated water) and/or a heating gas 354 (e.g., heated CO₂, air, or inert gas such as nitrogen) to a heating fluid control 356 (e.g., steam and/or heating fluid control) of the heating fluid supply system 316.

The heating fluid control 356 includes one or more heating fluid control components 358, 360, and 362, which may be configured to process, adjust, and/or control characteristics of the heating fluid 352 and/or heating gas 354 upstream from the conduits 254 (e.g., 256, 258, and 260) of the sorbent-based gas capture units 252 (e.g., 252A, 252B, and 252C). For example, the heating fluid control component 358 may include a thermal control component (e.g., temperature control component), such as a heat exchanger, a heater, a cooler, or any combination thereof, configured to adjust (e.g., increase or decrease) a temperature of the heating fluid 352 and/or the heating gas 354. The heat exchanger may exchange heat with water, lubricant, coolant, refrigerant, or some other thermal fluid. In some embodiments, a waste heat recovery system may be used for heat transfer in the heat exchanger. The heating fluid control component 360 may include a pressure control component, such as a pressure regulator, an expander or expansion chamber, a constrictor or constriction chamber, a fan or pump to add energy, a turbine to extract energy, or another suitable pressure controller. The heating fluid control component 362 may include a pre-treatment component, such as a particulate filter, a cold water drain, and/or other pre-treatment components configured to alter characteristics of the heating fluid 352 and/or the heating gas 354 or remove contaminants.

The heating fluid supply system 316 also may include one or more valves 364 configured to control the distribution of the heating fluid 352 (e.g., steam and/or heated water) and/or the heating gas 354 to the plurality of conduits 254 (e.g., 256, 258, and 260) of the sorbent-based gas capture units 252 (e.g., 252A, 252B, and 252C) via distribution conduits 366, 368, and 370. For example, the valves 364 may include one or more multi-way valves and/or distribution manifolds to independently distribute the heating fluid 352 (e.g., steam and/or heated water) and/or the heating gas 354 through the distribution conduits 366, 368, and 370 to the respective sorbent-based gas capture units 252 (e.g., 252A, 252B, and 252C) when operating in a desorption mode in response to control signals from the controller 220.

The cooling fluid supply system 318 of the upstream flow distribution system 310 is configured to supply a cooling fluid to enable the cooling mode when selectively operating each of the sorbent-based gas capture units 252 (e.g., 252A, 252B, and 252C) in the cooling mode via the controller 220. The cooling fluid supply system 318 includes one or more cooling fluid supplies 372, such as one or more water supplies, cooled air supplies, cooled inert gas (e.g., nitrogen) supplies, cooled CO₂ supplies, or any combination thereof. The cooling fluid supplies 372 may be configured to supply a coolant or cooling fluid 374 (e.g., liquid or gas coolant) to a cooling fluid control 376 of the cooling fluid supply system 318.

The cooling fluid control 376 includes one or more cooling fluid control components 378, 380, and 382, which may be configured to process, adjust, and/or control characteristics of the cooling fluid 374 upstream from the conduits 254 (e.g., 256, 258, and 260) of the sorbent-based gas capture units 252 (e.g., 252A, 252B, and 252C). For example, the cooling fluid control component 378 may include a thermal control component (e.g., temperature control component), such as a heat exchanger, a heater, a cooler, or any combination thereof, configured to adjust (e.g., increase or decrease) a temperature of the cooling fluid 374. The heat exchanger may exchange heat with water, lubricant, coolant, refrigerant, or some other thermal fluid. The cooling fluid control component 380 may include a pressure control component, such as a pressure regulator, an expander or expansion chamber, a constrictor or constriction chamber, a fan or pump to add energy, a turbine to extract energy, or another suitable pressure controller. The cooling fluid control component 382 may include a pre-treatment component, such as a particulate filter and/or other pre-treatment components, configured to alter characteristics of the cooling fluid 374 or remove contaminants.

The cooling fluid supply system 318 also may include one or more valves 384 configured to control the distribution of the cooling fluid 374 (e.g., liquid or gas coolant) to the plurality of conduits 254 (e.g., 256, 258, and 260) of the sorbent-based gas capture units 252 (e.g., 252A, 252B, and 252C) via distribution conduits 386, 388, and 390. For example, the valves 384 may include one or more multi-way valves and/or distribution manifolds to independently distribute the cooling fluid 374 through the distribution conduits 386, 388, and 390 to the respective sorbent-based gas capture units 252 (e.g., 252A, 252B, and 252C) when operating in a cooling mode in response to control signals from the controller 220.

In the illustrated embodiment, the controller 220 is configured to control the upstream flow distribution system 310 to alternatingly distribute flows of the gas 340 during the adsorption mode, the heating fluid 352 and/or the heating gas 354 in the desorption mode, and the cooling fluid 374 in the cooling mode to the different sorbent-based gas capture units 252 (e.g., 252A, 252B, and 252C) having sorbent material 272 and PCMs 282. In the adsorption mode, the gas 340 (e.g., intake gas 60 or exhaust gas 152, 184) flows through the conduit 254 of the selected sorbent-based gas capture unit 252 (e.g., 252A, 252B, or 252C) and contacts the sorbent material 272 disposed on the interior surface 274 of the outer conduit wall 262 and/or the exterior surface 276 of the contactors 280, such that the sorbent material 272 adsorbs the undesirable gases (e.g., CO₂) from the gas 340. The PCMs 282 absorb heat generated during the adsorption of undesirable gases, thereby helping to maintain the temperature within a suitable temperature range (e.g., between upper and lower temperature thresholds). Additionally, the thermal control system 290 may circulate a coolant through the heat exchanger 296 to provide cooling of the contactors 280, the sorbent material 272, and the PCMs 282. The thermal control system 290 also may facilitate heat transfer to the coolant via a plurality of heat pipes 298 of the heat exchanger 296. The sorbent-based gas capture unit 252 then discharges a treated gas 400 (e.g., lean or substantially free of the undesirable gases) to the post-adsorption processing system 320.

In the desorption mode, the heating fluid 352 and/or the heating gas 354 flows through the conduit 254 of the selected sorbent-based gas capture unit 252 (e.g., 252A, 252B, or 252C) and contacts the sorbent material 272 disposed on the interior surface 274 of the outer conduit wall 262 and/or the exterior surface 276 of the contactors 280, thereby heating the sorbent material 272 to facilitate desorption of the undesirable gases (e.g., CO₂) from the sorbent material 272. In some embodiments, the desorption mode may be configured to indirectly heat the sorbent material 272 via a heating circuit (e.g., heating conduit) extending through the sorbent-based gas capture unit 252. For example, the thermal control system 290 may circulate a heating fluid through the heat exchanger 296 to provide heating of the contactors 280, the sorbent material 272, and the PCMs 282. The thermal control system 290 also may facilitate heat transfer from the heating fluid across the contactors 280 via the plurality of heat pipes 298 of the heat exchanger 296. The sorbent-based gas capture unit 252 then discharges a fluid flow 402 including the undesirable gas, the heating fluid 352, and/or the heating gas 354 for further processing by the post-desorption processing system 322. During the desorption mode, the PCMs 282 also may absorb heat from the heating fluid 352 and/or the heating gas 354. However, the cooling mode is configured to extract the heat from the PCMs 282 prior to a subsequent adsorption mode.

In the cooling mode, the cooling fluid 374 flows through the conduit 254 of the selected sorbent-based gas capture unit 252 (e.g., 252A, 252B, or 252C) and contacts the sorbent material 272 disposed on the interior surface 274 of the outer conduit wall 262 and/or the exterior surface 276 of the contactors 280, thereby cooling the sorbent material 272, the PCMs 282, and the contactors 280. In some embodiments, the cooling mode may be configured to indirectly cool the sorbent material 272, the PCMs 282, and the contactors 280 via a cooling circuit (e.g., cooling conduit) extending through the sorbent-based gas capture unit 252. For example, the thermal control system 290 may circulate a cooling fluid through the heat exchanger 296 to provide cooling of the contactors 280, the sorbent material 272, and the PCMs 282. The thermal control system 290 also may facilitate heat transfer away from the contactors 280, the sorbent material 272, and the PCMs 282 via the plurality of heat pipes 298 of the heat exchanger 296. The cooling mode is configured to cool and regenerate the PCMs 282 by driving a phase change prior to a subsequent adsorption mode. The sorbent-based gas capture unit 252 then discharges a fluid flow 404 (e.g., cooling fluid 374) for handling by the post-cooling system 324.

In certain embodiments, the sorbent-based gas capture system 250 includes a movable sorbent system configured to continuously or periodically move the sorbent material 272 and PCMs 282 between the adsorption mode, the desorption mode, and the cooling mode. For example, the sorbent-based gas capture system 250 may include a rotating contactor assembly or wheel (e.g., rotating contactors with sorbent material 272 and PCM 282) configured to rotate from adsorption, desorption and cooling, thereby providing a continuous stream of captured undesirable gases. For example, the wheel (e.g., rotating contactors with sorbent material 272 and PCM 282) may extend into each of the plurality of conduits 254, and continuously rotate through the conduits 254. During the wheel rotation, one or more of the conduits 254 flow the gas 340 being treated to remove the undesirable gases, while one or more of the conduits 254 simultaneously flow the heating fluid 352 and/or heating gas 354 to remove and capture the undesirable gas (e.g., CO₂) to generate the captured gas 204, and while one or more of the conduits 254 simultaneously flow the cooling fluid 374 to regenerate the PCMs 282. For the desorption, the heating fluid 352 and/or heating gas 354 may be routed or generally configured to provide direct heat transfer and/or indirect heat transfer to the sorbent material 272, thereby helping to separate and capture the undesirable gas.

In the illustrated embodiment, the controller 220 is configured to control the downstream flow distribution system 312 to alternatingly distribute flows from each sorbent-based gas capture unit 252 (e.g., 252A, 252B, and 252C) to route the treated gas 400 to the post-adsorption processing system 320 during the adsorption mode, the fluid flow 402 (e.g., the undesirable gas, the heating fluid 352, and/or the heating gas 354) to the post-desorption processing system 322 in the desorption mode, and the fluid flow 404 (e.g., cooling fluid 374) to the post-cooling system 324 in the cooling mode. In certain embodiments, the downstream flow distribution system 312 includes one or more valves 410 fluidly coupled with the sorbent-based gas capture unit 252A, one or more valves 412 fluidly coupled with the sorbent-based gas capture unit 252B, and one or more valves 414 fluidly coupled with the sorbent-based gas capture unit 252C. The valves 410 may include one or more multi-way valves and/or distribution manifolds coupled to distribution conduits 416, 418, and 420, which are coupled to the post-adsorption processing system 320, the post-desorption processing system 322, and the post-cooling system 324, respectively. The valves 412 may include one or more multi-way valves and/or distribution manifolds coupled to distribution conduits 422, 424, and 426, which are coupled to the post-adsorption processing system 320, the post-desorption processing system 322, and the post-cooling system 324, respectively. The valves 414 may include one or more multi-way valves and/or distribution manifolds coupled to distribution conduits 428, 430, and 432, which are coupled to the post-adsorption processing system 320, the post-desorption processing system 322, and the post-cooling system 324, respectively. In operation, the controller 220 is configured to control the valves 410, 412, and 414 to independently control the flows from the sorbent-based gas capture units 252 (e.g., 252A, 252B, and 252C) to the post-adsorption processing system 320 in the adsorption mode, to the post-desorption processing system 322 in the desorption mode, and to the post-cooling system 324 in the cooling mode.

The post-adsorption processing system 320 includes a treated gas processing system 440, which may include an exhaust stack, an additional gas treatment system, or any other suitable post processing equipment. In certain embodiments, the post-adsorption processing system 320 may recirculate all or part of the treated gas 400 to the EGR system 150 as discussed above with reference to FIG. 1.

The post-desorption processing system 322 may include a post-desorption processor 442 having one or more post-desorption processing components 444, 446, and 448. In certain embodiments, the fluid flow 402 directed to the post-desorption processor 442 is a result of the desorption mode, wherein the heating fluid 352 (e.g., steam and/or heated water) and/or heating gas 354 is directed through the conduit 254 of the sorbent-based gas capture unit 252 (e.g., 252A, 252B, or 252C) to desorb the undesirable gases (e.g., CO₂) from the sorbent material 272. Accordingly, the one or more post-desorption processing components 444, 446, and 448 (e.g., gas, steam, and/or heated water processing components) may be configured to process, adjust, and/or control characteristics of the fluid flow 402 (e.g., gas, steam, and/or heated water flow) from the conduits 254 (e.g., 256, 258, and 260) of the sorbent-based gas capture units 252 (e.g., 252A, 252B, and 252C). For example, the post-desorption processing component 444 may include a captured gas/heated fluid separator configured to separate the heating fluid 352 (e.g., steam and/or heated water) and/or the heating gas 354 from the captured gas, thereby outputting a water 450 (e.g., condensate) and the captured gas 204. Examples of the captured gas/heated fluid separator include thermal control components, pressure control components, chemical separation components, or a combination thereof. For example, the captured gas/heated fluid separator may be configured to condense or cool the heating fluid 352 (e.g., steam) using a condenser. The post-desorption processing component 446 may include one or more removal units configured to remove contaminants from the water 450 and/or the captured gas 204. For the water 450, the removal units may include particulate filters and/or water treatment units. For the captured gas 204, the removal units may include particulate filters, water removal units or dryers, or further gas treatment units. The post-desorption processing component 448 may include one or more pressure control components and/or flow control components, such as one or more pumps for the water 450 and one or more compressors for the captured gas 204. The post-desorption processing components 448 also may include a vacuum system having one or more vacuum pumps configured to suction the captured gas/heated fluid flow from the sorbent-based gas capture units 252. In other words, the vacuum pumps are configured to create a low-pressure environment to help draw the captured gas/heated fluid flow from the sorbent-based gas capture units 252.

The post-cooling system 324 may include a cooling fluid recirculation system 452, which is configured to recirculate the fluid flow 404 back to the cooling fluid supply system 318 as the cooling fluid 374. The cooling fluid recirculation system 452 may include components 454, 456, and 458, such as a recirculation pump, compressor, or booster fan, a cooling system, and flow control valves. The cooling system may include a heat exchanger configured to transfer heat away from the fluid flow 404, thereby cooling the fluid flow for additional use as the cooling fluid 374. In certain embodiments, the heat available from the fluid flow 404 may be recovered in one or more heat exchangers to heat the heating fluid 352 and/or heating gas 354 of the heating fluid supply system 316, thereby reducing the total heating energy demand. The remaining low grade heat from the fluid flow 404 may then be rejected to ambient.

The controller 220 is configured to receive feedback from the sensors 222 to facilitate adjustments of various operating parameters and change operating modes (e.g., adsorption mode, desorption mode, and cooling mode) of the sorbent-based gas capture units 252 (e.g., 252A, 252B, and 252C). For example, the controller 220 may be configured to alternate flows (e.g., gas 340, heating fluid 352 and/or heating gas 354, and cooling fluid 374) through the plurality of conduits 254 (e.g., 256, 258, and 260), such that the sorbent-based gas capture units 252 (e.g., 252A, 252B, and 252C) can alternate between the adsorption mode, the desorption mode, and the cooling mode. In the adsorption mode, the conduit 254 receives a flow of the gas 340, adsorbs the undesirable gases (e.g., CO₂) from the gas 340 into the sorbent material 272, and outputs a treated gas 400 with a reduced content or concentration level of the undesirable gases. The adsorption of undesirable gases into the sorbent material 272 is an exothermic process, which generates heat. The thermal control system 290, including the PCMs 282, the heat exchangers 296, and the heat pipes 298, help to regulate the temperature of the sorbent material 272 during the adsorption mode, thereby maintaining or increasing the adsorption efficiency of the sorbent material 272. In the desorption mode, the conduit 254 receives a flow of the heating fluid 352 (e.g., steam and/or heated water) and/or heating gas 352, desorbs the undesirable gases (e.g., CO₂) from the sorbent material 272 into the heating fluid 352 and/or heating gas 352, and outputs the fluid flow 402 with the desorbed undesirable gases (e.g., heating fluid 352 and/or heating gas 354 rich in the undesirable gases such as CO₂). The desorption of undesirable gases from the sorbent material 272 is an endothermic process, and the heating fluid 352 and/or heating gas 352 provides sufficient heat (e.g., directly or indirectly) to drive the desorption of the undesirable gases (e.g., CO₂) from the sorbent material 272. In the cooling mode, the conduit 254 receives a flow of the cooling fluid 374 (e.g., gas or liquid coolant), thereby cooling the sorbent material 272, the contactors 280, and the PCMs 282. The cooling of PCMs 282 causes a change of phase, such that the PCMs 282 are regenerated for another adsorption mode.

The controller 220 is configured to monitor the sensors 222, such as sensors 222 at or upstream from the inlets 266 and sensors 222 at or downstream from the outlets 268, to evaluate rates of adsorption, desorption, and cooling, concentration levels of the undesirable gases, and other characteristics impacting the operating modes of the sorbent-based gas capture units 252 (e.g., 252A, 252B, and 252C). If the sensors 222 indicate a need to alternate operating modes (e.g., adsorption, desorption, and cooling modes) of the sorbent-based gas capture units 252 (e.g., 252A, 252B, and 252C), then the controller 220 may be configured to control the valves 342, 364, 384, 410, 412, and 414 to change the flows through the conduits 254 to support the desired operating modes. The sensors 222 also may monitor the temperature of the sorbent material 272 and/or PCM 282 and adjust the thermal control system 290 to provide heating or cooling depending on the operating mode (e.g., cooling during the adsorption and cooling modes and heating during the desorption mode).

For the gas 340 treated in one of the conduits 254 in the adsorption mode, the controller 220 may be configured to control the gas pre-treatment system 330 to control characteristics of the gas 340 (e.g., temperature, pressure, flow rate, etc.). Similarly, the controller 220 is configured to control the treated gas processing system 440 to control the processing of the treated gas 400 discharged from one or more of the conduits 254. For the heating fluid 352 (e.g., steam and/or heated water) and/or the heating gas 354 supporting the desorption mode in one of the conduits 254, the controller 220 may be configured to control the HRSG 16, the steam turbine system 14, the heating fluid control 356, or any combination thereof, to control characteristics of the heating fluid 352 and/or the heating gas 354 (e.g., temperature, pressure, flow rate, steam content, water content, etc.). Similarly, the controller 220 is configured to control the post-desorption processor 442 to control the processing of the fluid flow 402 (including the undesirable gas desorbed during the desorption mode) discharged from one or more of the conduits 254. For the cooling fluid 374 supporting the cooling mode in one of the conduits 254, the controller 220 may be configured to control the cooling fluid control 376 and/or the cooling fluid recirculation system 452 to control characteristics of the cooling fluid 374 (e.g., temperature, pressure, flow rate, etc.). Similarly, the controller 220 is configured to control the cooling fluid recirculation system 452 to control the processing of the fluid flow 404 (e.g., cooling fluid 374) discharged from one or more of the conduits 254.

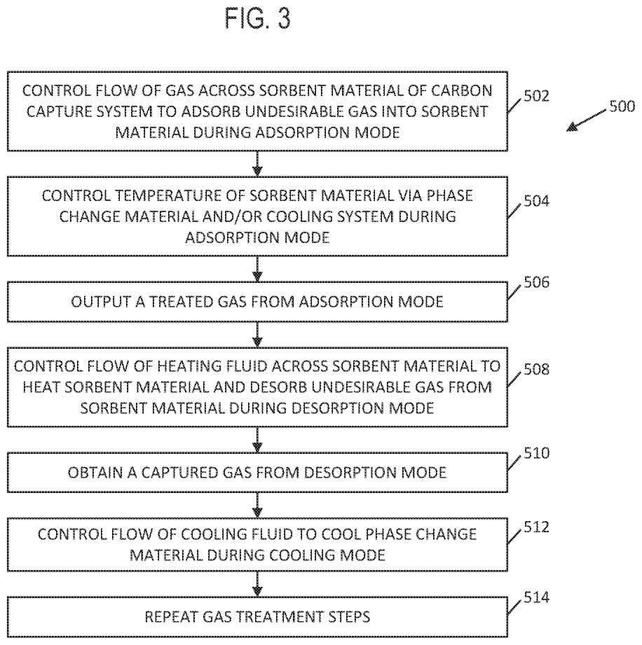

FIG. 3 is a flow chart of an embodiment of a gas treatment process 500 of the gas treatment system 18 of FIGS. 1-2, such as the gas capture system 20 (e.g., sorbent-based gas capture system 250). The process 500 may be controlled via the controller 220 or another suitable controller, computer, or electronic device. As illustrated, the process 500 includes controlling a flow of gas (e.g., exhaust gas) across a sorbent material of a carbon capture system to absorb undesirable gas (e.g., CO₂) into the sorbent material during an absorption mode (block 502). For example, the gas 340 may flow across the sorbent material 272 in one of the sorbent-based gas capture units 252, such as sorbent material 272 along the interior surface 274 of the outer conduit wall 262 and/or the exterior surface 276 of the contactors 280. The process 500 also includes controlling a temperature of the sorbent material via a phase change material (PCM) and/or a cooling system during the adsorption mode (block 504). For example, the sorbent-based gas capture unit 252 may include the PCM 282 covered by the sorbent material 272, wherein the PCM 282 absorbs heat generated due to the adsorption of the undesirable gases (e.g., CO₂) into the sorbent material 272 to cause a phase change of the PCM 282. During the phase change, the PCM 282 helps to control the temperature of the sorbent material 272 within upper and lower temperature thresholds. Additionally, the sorbent-based gas capture unit 252 may include the cooling system 292 coupled to heat exchangers 296 having heat pipes 298, wherein the heat exchangers 296 and heat pipes 298 may be coupled to the contactors 280 of the contactor assembly 278. The heat exchangers 296 are configured to circulate a cooling fluid 374 (e.g., liquid or gas coolant) to help cool the sorbent material 272, while the heat pipes 298 help transfer heat from the contactors 280 to the cooling fluid. In turn, the process 500 outputs a treated gas from the adsorption mode (block 506). For example, the treated gas may include the treated gas 400 (e.g., lean or substantially free of the undesirable gases), such as the exhaust gas lean or substantially free of CO_{2.}

After the adsorption mode, the process 500 may include controlling a flow of heating fluid across the sorbent material to heat the sorbent material and desorb the undesirable gas from the sorbent material during a desorption mode (block 508). For example, the heating fluid may include the heating fluid 352 (e.g., steam and/or heated water) and/or the heating gas 354 (e.g., heated CO₂, air, or inert gas such as nitrogen), which heats the sorbent material 272 to desorb the undesirable gas (e.g., CO₂). The heating fluid also may further heat (e.g., sensible heat rather than latent heat) the PCM 282 during the desorption mode. In turn, the process 500 obtains a captured gas from the desorption mode (block 510). The captured gas may include the captured gas 204, such as CO_{2.}

After the desorption mode, the process 500 may include controlling a flow of cooling fluid to cool the PCM during a cooling mode (block 512). For example, the cooling fluid supply system 318 may supply a cooling fluid 374 (e.g., liquid or gas coolant) to the sorbent-based gas capture unit 252, thereby cooling the PCM 282 to cause a phase change and regeneration of the PCM 282 prior to a subsequent absorption mode. By further example, the cooling system 292 may supply a cooling fluid 374 (e.g., liquid or gas coolant) to the sorbent-based gas capture unit 252, thereby cooling the PCM 282 to cause a phase change and regeneration of the PCM 282 prior to a subsequent absorption mode. The process 500 may then proceed to repeat another cycle of the absorption mode, the desorption mode, and the cooling mode (block 514), as illustrated by steps 502, 504, 506, 508, 510, and 512.

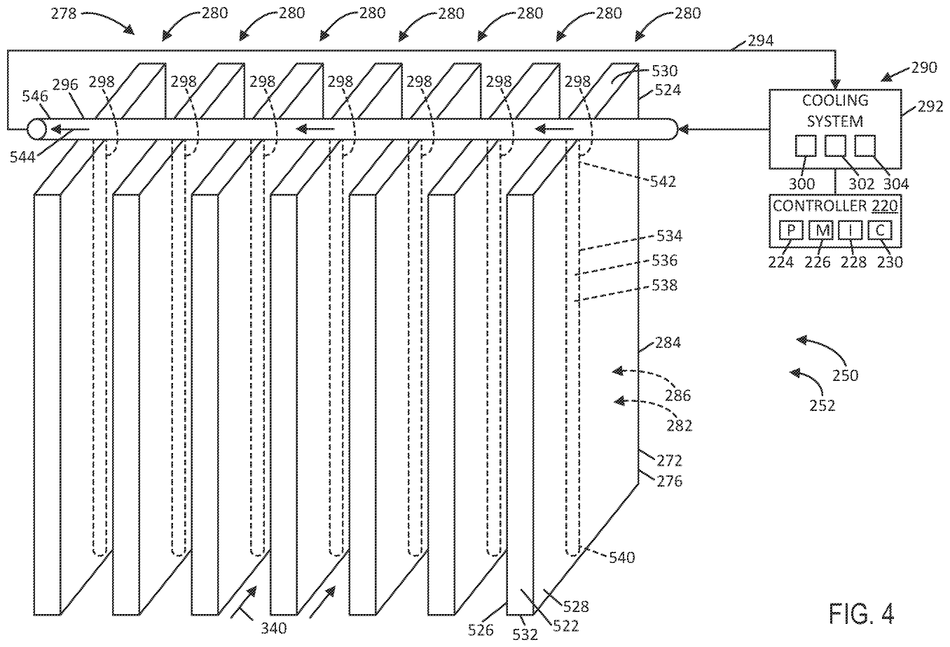

FIG. 4 is a perspective view of an embodiment of the gas capture system 20 (e.g., the sorbent-based gas capture system 250) of FIG. 2, further illustrating an embodiment of the contactor assembly 278 of the sorbent-based gas capture unit 252 and the thermal control system 290. In the illustrated embodiment, the contactor assembly 278 includes a plurality of the contactors 280 disposed parallel to one another, wherein the sorbent-based gas capture system 250 is configured to flow the gas 340 (e.g., intake gas 60 or exhaust gas 152, 184) around and between the plurality of contactors 280. Additionally, the sorbent-based gas capture system 250 includes the thermal control system 290 having the cooling system 292 coupled to the contactor assembly 278. The cooling system 292 includes the cooling circuit 294 having the heat exchanger 296 coupled to each contactor 280 in the contactor assembly 278, wherein each contactor 280 includes one or more heat pipes 298 coupled to the heat exchanger 296. As discussed in further detail below, each contactor 280 in the contactor assembly 278 includes the sorbent material 272 and the PCM 282.

In the illustrated embodiment, each contactor 280 includes the body 284 having the exterior surface 276 disposed about the interior portion 286, wherein the body 284 includes a panel 520 (e.g., fin, plate, or sheet) extending from an upstream wall 522 (e.g., leading edge or nose portion) to a downstream wall 524 (e.g., trailing edge or tail portion), opposite side walls 526 and 528 (e.g., opposite faces) extending from the upstream wall 522 to the downstream wall 524, and opposite walls 530 and 532 (e.g., top and bottom edges) extending from the upstream wall 522 to the downstream wall 524. In certain embodiments, the panel 520 may be a flat panel, such as a flat rectangular panel, extending parallel to a plane in a flow direction of the gas 340. Accordingly, the opposite side walls 526 and 528 may be flat parallel side walls. In some embodiments, the panel 520 may be an airfoil shaped body (e.g., airfoil), wherein the opposite side walls 526 and 58 curve from the upstream wall 522 to the downstream wall 524. However, the panel 520 is not limited to any particular geometry. The panel 520 may be solid or hollow depending on the construction to support the PCM 282. Accordingly, as discussed in further detail below, the panel 520 may be substantially or entirely made of the PCM 282 (e.g., solid-solid PCM), the panel 520 may house or contain the PCM 282 (e.g., solid-solid PCM, solid-liquid PCM, solid-gas PCM, or liquid-gas PCM) within the interior portion 286, or a combination thereof.

Each contactor 280 has one or more heat pipes 298 extending internally through the interior portion 286 of the body 284, externally along the exterior surface 276 of the body 284, or a combination thereof, wherein the heat pipes 298 are mechanically and thermally coupled to the heat exchanger 296. Each heat pipe 298 may include a casing or enclosure 534 disposed about a chamber 536 containing a working fluid 538. For example, the heat pipe 298 may include an evaporator or evaporating portion 540 and a condenser or condensing portion 542 on opposite end portions of the heat pipe 298, wherein the condensing portion 542 is directly adjacent to (e.g., in contact with) the heat exchanger 296 and the evaporating portion 540 is distal (e.g., offset) from the heat exchanger 296 and in contact with the contactor 280.

In operation, the heat pipe 298 transfers heat from the contactor 280 through the enclosure 534 into the working fluid 538 at the evaporating portion 540, causing a phase change of the working fluid 538 from a liquid phase to a vapor phase. The working fluid 538 (e.g., vapor phase) then travels or circulates through the heat pipe 298 from the evaporating portion 540 to the condensing portion 542. At the condensing portion 542, the heat exchanger 296 transfers heat away from the working fluid 538 into a cooling fluid 544 (e.g., liquid or gas coolant) circulating through the cooling circuit 294, thereby cooling and condensing the working fluid 538 into the liquid phase. The working fluid 538 (e.g., liquid phase) then travels or circulates through the heat pipe 298 from the condensing portion 542 to the evaporating portion 540, wherein heat is again transferred from the contactor 280 into the working fluid 538 to cause a phase change from the liquid phase to the vapor phase. Accordingly, the heat pipe 298 is configured to repeatedly perform a cycle of evaporating and condensing in the heat pipe 298, thereby transferring heat from the contactor 280 to the heat exchanger 296 via the working fluid 538. The working fluid 538 may be selected based on a desired operating temperature, and thus may include ammonia, alcohol, (e.g., methanol or ethanol), water, or any combination of working fluids. The chamber 536 also may include a wick structure configured to facilitate a capillary action on the liquid phase of the working fluid 538.

The heat exchanger 296 may include a variety of configurations and connections with the contactors 280. In the illustrated embodiment, the heat exchanger 296 includes a fluid conduit 546 coupled to each of the contactors 280 and respective heat pipes 298. In some embodiments, the heat exchanger 296 may include a plurality of parallel fluid conduits 546, wherein each of the fluid conduits 546 is independently coupled to each of the contactors 280 and respective heat pipes 298. In some embodiments, the fluid conduit 546 may extend across at least 50, 60, 70, 80, 90, or 100 percent of the wall 530 of each contactor 280, and couple to multiple heat pipes 298 (e.g., 2, 3, 4, 5, 6, 7, 8, 9, 10, or more) at each contactor 280. In some embodiments, the fluid conduit 546 may include a winding conduit, a spiraling conduit, or a combination thereof, wherein the fluid conduit 546 may include a plurality of independent contact points (e.g., thermal and mechanical contacts) along the wall 530 of each contactor 280. In some embodiments, as discussed in further detail below, the cooling circuit 294 may extend through the heat exchanger 296 (e.g., fluid conduit 546) and one or more cooling circuits within each contactor 280 of the contactor assembly 278. Additionally, as discussed in further detail below, each contactor 280 of the contactor assembly 278 may include a plurality of fins to increase the surface area of the exterior surface 276, thereby providing more surface area for the sorbent material 272 and more surface area for heat transfer.

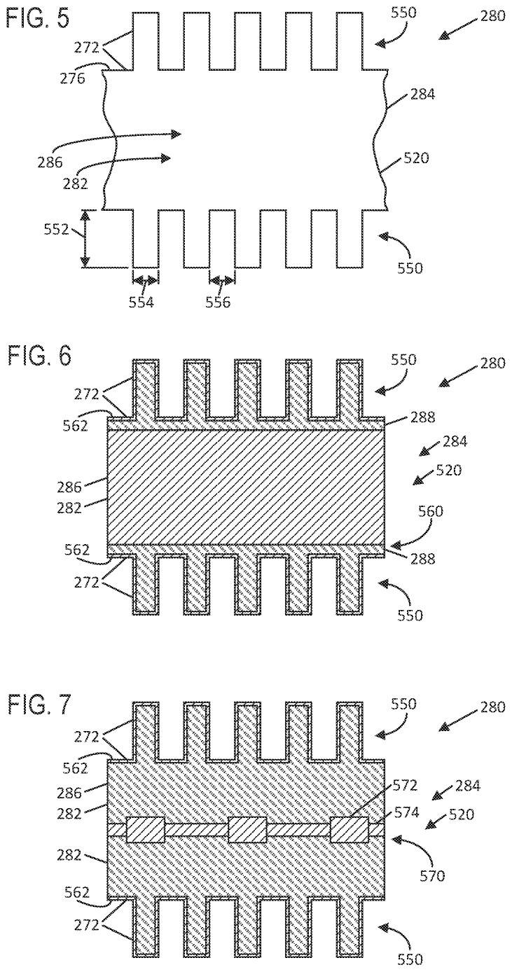

FIG. 5 is a partial side view of an embodiment of the contactor 280 of the contactor assembly 278 of FIGS. 2 and 4, further illustrating a plurality of fins 550 protruding from the body 284 of the contactor 280. Each contactor 280 of the contactor assembly 278 may include the plurality of fins 550 along any portion or all of the exterior surface 276, including one or more of the upstream wall 522, the downstream wall 524, the opposite side walls 526 and 528, the opposite walls 530 and 532, or any combination thereof. In the illustrated embodiment, the fins 550 are rectangular plates oriented parallel to one another. The fins 550 may include a height 552, a width 554, and a spacing 556, which may be constant or variable on the various walls of the exterior surface 276. The height 552 may be greater than the width 554, such as at least 2, 3, 4, 5, 6, 7, 8, 9, or 10 times greater than the width 554. The spacing 556 may be less than, equal to, or greater than the width 554.

As discussed in further detail below, the fins 550 and/or the body 284 may be at least substantially or entirely made of a thermally conductive material, the PCM 282, or a combination thereof, while the sorbent material 272 is disposed outside of the body 284 (e.g., along the exterior surface 276). In certain embodiments, the fins 550 may be integrally formed with the body 284 as a continuous one-piece structure, wherein the body 284 may be a solid body or a hollow body. With a hollow construction of the body 284, the PCM 282 may be disposed inside of the body 284 (e.g., within the interior portion 286), while the sorbent material 272 is disposed outside of the body 284 (e.g., along the exterior surface 276). With a solid construction of the body 284, the PCM 282 may form all or part of the structure of the body 284 including the fins 550, while the sorbent material 272 is disposed outside of the body 284 (e.g., along the exterior surface 276). In certain embodiments, the fins 550 may be removably or fixedly coupled to the body 284.

FIG. 6 is a cross-sectional side view of an embodiment of the contactor 280 of the contactor assembly 278 of FIGS. 2, 4, and 5, further illustrating an embodiment of a construction of the contactor 280. In the illustrated embodiment, the body 284 of the contactor 280 has the outer wall 288 defining an enclosure 560 (e.g., outer shell, casing, or container) disposed about the interior portion 286, wherein the interior portion 286 includes the PCM 282. The fins 550 may be integrally formed with the outer wall 288 as a continuous one-piece structure or the fins 550 may be removably or fixed coupled with the outer wall 288. The sorbent material 272 is disposed on the exterior surface 276 of the body 284 in one or more layers 562, wherein the one or more layers 562 of the sorbent material 272 may at least substantially or completely cover the exterior surface 276. In particular, the one or more layers 562 of the sorbent material 272 extend over the exterior surface 276 of the outer wall 288 defining the enclosure 560, including the fins 550. The one or more layers 562 of the sorbent material 272 may have a sorbent material thickness that is less than, equal to, or greater than a wall thickness of the outer wall 288. The PCM 282 disposed in the interior portion 286 may include any one or more PCM materials, including one or more solid-liquid PCMs, solid-solid PCMs, solid-gas PCMs, liquid-gas PCMs, or any combination thereof. For example, the interior portion 286 may include a hollow cavity or chamber, which is at least substantially or completely filled with the PCM 282. By further example, the interior portion 286 may be a solid structure made of a solid-solid PCM 282.

In certain embodiments, the sorbent material 272 may include any of the sorbent materials described above in the one or more layers 562, the body 284 and fins 550 may include a thermally conductive material, and the interior portion 286 includes the PCM 282. Thus, the body 284 and the fins 550 provide a conductive heat transfer path between the sorbent material 272 and the PCM 282. The thermally conductive material of the body 284 and the fins 550 (including the outer wall 288 defining the enclosure 560) may include a thermally conductive metal (e.g., aluminum, copper, etc.), a thermally conductive composite material (e.g., a base material having a plurality of thermally conductive additives, such as fibers, particles, etc.), or any combination thereof. The thermally conductive composite material may include a thermally conductive polymer or polymer composite (e.g., a polymer with thermally conductive additives), wherein the thermally conductive additives may include alumina, silica, boron nitride, aluminum nitride, silicon carbide, graphite, diamond, graphene, carbon nanotubes, carbon fibers, or any combination thereof.

FIG. 7 is a cross-sectional side view of an embodiment of the contactor 280 of the contactor assembly 278 of FIGS. 2, 4, and 5, further illustrating an embodiment of a construction of the contactor 280 having a solid-solid PCM 282. In the illustrated embodiment, the body 284 of the contactor 280 has the interior portion 286 substantially or entirely formed with the PCM 282 (e.g., solid-solid PCM). In other words, the body 284 of the contactor 280 excludes the outer wall 288 defining the enclosure 560, and instead defines the structure of the body 284 with the PCM 282 (e.g., solid-solid PCM). In certain embodiments, the body 284 may include or exclude an internal support structure or framework 570 having a plurality of interconnected beams 572 and cross supports 574 within the PCM 282 (e.g., solid-solid PCM), wherein the framework 570 is configured to provide structural support for the PCM 282 and the entire contactor 280. In the illustrated embodiment, the PCM 282 (e.g., solid-solid PCM), which forms the body 284, is directly covered by the one or more layers 562 of the sorbent material 272. In other words, the one or more layers 562 of the sorbent material 272 are disposed directly on the PCM 282 (e.g., solid-solid PCM). As a result, a conductive heat transfer path exists directly between the sorbent material 272 and the PCM 282. In some embodiments, one or more intermediate layers may be disposed between the PCM 282 and the sorbent material 272. The intermediate layers also may enable a conductive heat transfer path between the sorbent material 272 and the PCM 282.

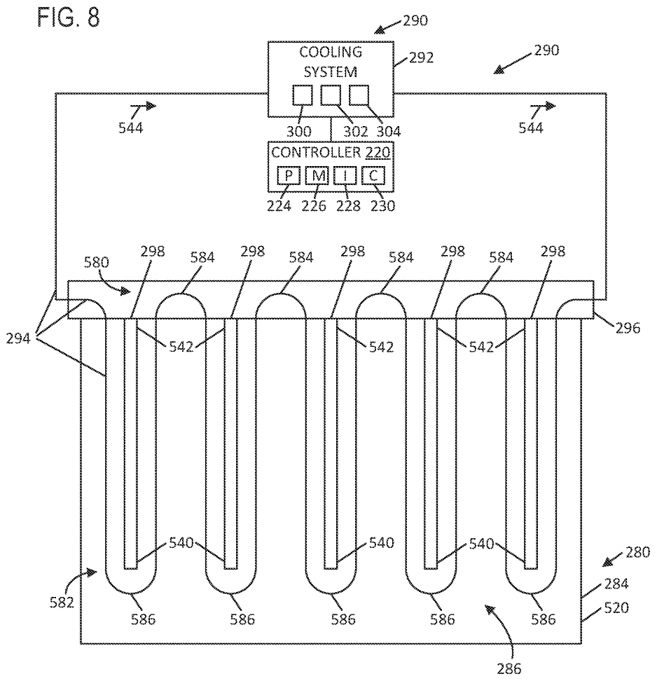

FIG. 8 is a schematic view of an embodiment of the thermal control system 290 of FIGS. 2 and 4, further illustrating an embodiment of the cooling circuit 294, the heat exchanger 296, and the heat pipes 298 coupled to the contactor 280 of the contactor assembly 278. In the illustrated embodiment, the cooling circuit 294 includes a circuit portion 580 disposed in the heat exchanger 296 and a circuit portion 582 disposed in the contactor 280 for each contactor 280 in the contactor assembly 278. The circuit portion 580 may include one or more cooling passages 584 (e.g., U-shaped cooling passages), and the circuit portion 580 may include one or more cooling passages 586 (e.g., U-shaped cooling passages). The cooling circuit 294 (e.g., circuit portions 580 and 582) may have any orientation and configuration of cooling passages, including horizontal, vertical, angled, or any combination thereof. The cooling passages 584 and 586 are mechanically and fluidly coupled together, thereby forming a portion of the cooling circuit 294 in the heat exchanger 296 and the contactor 280. The cooling passages 584 and 586 may include cooling tubes, conduits, or channels disposed integrally or separately through the heat exchanger 296 and the contactor 280. For example, the cooling passages 584 may be integrally formed in a body of the heat exchanger 296, while the cooling passages 586 may be integrally formed in the body 284 of the contactor 284. In the illustrated embodiment, the cooling circuit 294 alternates back and forth between the cooling passages 584 of the circuit portion 580 and the cooling passages 586 of the circuit portion 582, thereby defining a winding flow path through the heat exchanger 296 and the contactor 280. In some embodiments, the cooling circuit 294 may include a plurality of separate winding flow paths through the heat exchanger 296 and the contactor 280.

In the illustrated embodiment, the thermal control system 290 includes a plurality of the heat pipes 298 spaced apart from one another in the body 284 of the contactor 280. For example, the heat pipes 298 may be disposed within and/or along each of the cooling passages 586 (e.g., U-shaped cooling passages) of the circuit portion 582, wherein the heat pipes 298 are mechanically and thermally coupled to both the heat exchanger 296 and the contactor 280. In some embodiments, the thermal control system 290 includes any one or more of the heat pipes 298, the circuit portion 580 in the heat exchanger 296, the circuit portion 582 in the contactor 280, or any combination thereof.

In operation, the thermal control system 290 is configured to provide thermal control of the sorbent material 272, the PCM 282, and the contactor 280 during the various modes (e.g., adsorption mode, desorption mode, and cooling mode) as discussed above. For example, the thermal control system 290 may be configured to help cool the sorbent material 272 in combination with the thermal control provided by the PCM 282 during the adsorption mode. By further example, the thermal control system 290 may be configured to help heat the sorbent material 272 during the desorption mode. By further example, the thermal control system 290 may be configured to help cool and regenerate the PCM 282 during the cooling mode. For cooling purposes, the heat pipes 298 are configured to transfer heat from the contactor 280 to the heat exchanger 296, and the circuit portions 580 and 582 are configured to transfer heat from the contactor 280 and the heat exchanger 296 to the cooling fluid 544 circulating through the cooling circuit 296. For heating purposes, the heat transfer may be reversed in the heat exchanger 296 and the heat pipes 298, while the cooling fluid 544 may be heated and function as a heating fluid. In some embodiments, the thermal control system 290 may be used only for cooling purposes and/or primarily for cooling purposes, while heating functionality is provided for better thermal control. Accordingly, the PCMs 282 may be used alone or in combination with the heat exchanger 296 and the heat pipes 298 of the thermal control system 290, thereby helping to improve the efficiency of the sorbent-based gas capture system 250.

Technical effects of the invention include one or more PCMs 282 configured to help absorb heat during adsorption or absorption of undesirable gases, thereby increasing the efficiency of the adsorption or absorption process. For example, the PCMs 282 may absorb heat generated during adsorption of the undesirable gases into sorbent materials 272, thereby helping to reduce temperature increases in the sorbent material 272 that would otherwise cause reductions in the storage capacity (e.g., adsorption capacity) for the sorbent material 272 to adsorb the undesirable gases. As a result, the temperature of the sorbent material 272 can be controlled to remain below an upper temperature threshold and/or between upper and lower temperature thresholds, which generally results in a higher storage capacity (e.g., at least 50, 60, 70, or 80 percent greater adsorption capacity) for the sorbent material 272 as compared with higher temperatures.

The subject matter described in detail above may be defined by one or more clauses, as set forth below.

A system includes a gas capture system having a first adsorber with a first sorbent material and a first phase change material. The first sorbent material is configured to adsorb an undesirable gas from a gas flow during an adsorption mode. The first phase change material is configured to absorb heat during the adsorption mode to increase a capacity of the first sorbent material to adsorb the undesirable gas.

The system of the preceding claim, wherein the gas flow comprises an exhaust gas generated from a combustion system.

The system of any preceding claim, comprising a gas turbine system having the combustion system, an electrical generator driven by the gas turbine system, or a combination thereof.

The system of any preceding claim, wherein the gas capture system is a carbon capture system.

The system of any preceding claim, wherein the undesirable gas comprises carbon dioxide (CO₂).

The system of any preceding claim, wherein the first adsorber is configured to desorb the undesirable gas from the first sorbent material in a desorption mode, and the first adsorber is configured to cool and regenerate the first phase change material in a cooling mode.

The system of any preceding claim, comprising a controller coupled to the gas capture system, wherein the controller is configured to selectively change operating modes of the first adsorber in a sequence of the adsorption mode, the desorption mode, and the cooling mode.

The system of any preceding claim, wherein the controller is configured to enable the gas flow through the first adsorber in the adsorption mode, enable a heating fluid through the first adsorber in the desorption mode, and enable a cooling fluid through the first adsorber in the cooling mode.

The system of any preceding claim, wherein the gas capture system comprises a second adsorber having a second sorbent material and a second phase change material, the first adsorber comprises a first duct having a first contactor assembly having the first sorbent material and the first phase change material, and the second adsorber comprises a second duct having a second contactor assembly having the second sorbent material and the second phase change material.

The system of any preceding claim, wherein the gas capture system comprises a third adsorber having a third duct with a third contactor assembly having a third sorbent material and a third phase change material.

The system of any preceding claim, wherein the first phase change material comprises a solid-solid phase change material, a solid-liquid phase change material, a solid-gas phase change material, a liquid-gas phase change material, or any combination thereof.

The system of any preceding claim, wherein the first adsorber comprises a contactor having one or more heat pipes, a heat exchanger with a cooling circuit, a plurality of fins, or any combination thereof, wherein the contactor comprises the first sorbent material and the first phase change material.

The system of any preceding claim, wherein the heat is at least partially generated from the first sorbent material adsorbing the undesirable gas during the adsorption mode, wherein the first phase change material is configured to absorb the heat to enable the first sorbent material to operate between an upper temperature and a lower temperature during the adsorption mode.

The system of any preceding claim, wherein the first phase change material is configured to absorb the heat to enable the first sorbent material to operate in an isothermal operating mode.

The system of any preceding claim, comprising a conductive heat transfer path between the first sorbent material and the first phase change material.

The system of any preceding claim, wherein the first sorbent material is disposed directly on the first phase change material.

The system of any preceding claim, wherein the first sorbent material is disposed on a first side of a wall, the first phase change material is disposed on a second side of the wall, and the first and second sides are opposite to one another.

The system of any preceding claim, comprising an enclosure having the wall disposed about an interior portion, wherein the first phase change material is disposed in the interior portion, and the first sorbent material is disposed along an exterior surface of the wall.

A system includes a controller having a memory, a processor, and instructions stored on the memory and executable by the processor to selectively change operating modes of a gas capture system in a sequence of an adsorption mode, a desorption mode, and a cooling mode, wherein the gas capture system includes a first adsorber having a first sorbent material and a first phase change material. The controller is configured to control a gas flow through the first adsorber in the adsorption mode, wherein the first sorbent material is configured to adsorb an undesirable gas from the gas flow during the adsorption mode, and the first phase change material is configured to absorb heat during the adsorption mode to increase a capacity of the first sorbent material to adsorb the undesirable gas. The controller is configured to control heating of the first adsorber in the desorption mode, wherein the heating causes desorption of the undesirable gas from the first sorbent material. The controller is configured to control cooling of the first adsorber in the cooling mode, wherein the cooling regenerates the first phase change material prior to a subsequent operation in the adsorption mode.

A method includes selectively changing operating modes of a gas capture system in a sequence of an adsorption mode, a desorption mode, and a cooling mode, wherein the gas capture system includes a first adsorber having a first sorbent material and a first phase change material. The method includes controlling a gas flow through the first adsorber in the adsorption mode, wherein the first sorbent material is configured to adsorb an undesirable gas from the gas flow during the adsorption mode, and the first phase change material is configured to absorb heat during the adsorption mode to increase a capacity of the first sorbent material to adsorb the undesirable gas. The method includes controlling heating of the first adsorber in the desorption mode, wherein the heating causes desorption of the undesirable gas from the first sorbent material. The method includes controlling cooling of the first adsorber in the cooling mode, wherein the cooling regenerates the first phase change material prior to a subsequent operation in the adsorption mode.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a gas capture system, comprising:
a first adsorber having a first sorbent material and a first phase change material, wherein the first sorbent material is configured to adsorb an undesirable gas from a gas flow during an adsorption mode, and the first phase change material is configured to absorb heat during the adsorption mode to increase a capacity of the first sorbent material to adsorb the undesirable gas.

2. The system of claim 1, wherein the gas flow comprises an exhaust gas generated from a combustion system.

3. The system of claim 2, comprising a gas turbine system having the combustion system, an electrical generator driven by the gas turbine system, or a combination thereof.

4. The system of claim 1, wherein the gas capture system is a carbon capture system.

5. The system of claim 4, wherein the undesirable gas comprises carbon dioxide (CO₂).

6. The system of claim 1, wherein the first adsorber is configured to desorb the undesirable gas from the first sorbent material in a desorption mode, and the first adsorber is configured to cool and regenerate the first phase change material in a cooling mode.

7. The system of claim 6, comprising a controller coupled to the gas capture system, wherein the controller is configured to selectively change operating modes of the first adsorber in a sequence of the adsorption mode, the desorption mode, and the cooling mode.

8. The system of claim 7, wherein the controller is configured to enable the gas flow through the first adsorber in the adsorption mode, enable a heating fluid through the first adsorber in the desorption mode, and enable a cooling fluid through the first adsorber in the cooling mode.

9. The system of claim 1, wherein the gas capture system comprises a second adsorber having a second sorbent material and a second phase change material, the first adsorber comprises a first duct having a first contactor assembly having the first sorbent material and the first phase change material, and the second adsorber comprises a second duct having a second contactor assembly having the second sorbent material and the second phase change material.

10. The system of claim 9, wherein the gas capture system comprises a third adsorber having a third duct with a third contactor assembly having a third sorbent material and a third phase change material.

11. The system of claim 1, wherein the first phase change material comprises a solid-solid phase change material, a solid-liquid phase change material, a solid-gas phase change material, a liquid-gas phase change material, or any combination thereof.

12. The system of claim 1, wherein the first adsorber comprises a contactor having one or more heat pipes, a heat exchanger with a cooling circuit, a plurality of fins, or any combination thereof, wherein the contactor comprises the first sorbent material and the first phase change material.

13. The system of claim 1, wherein the heat is at least partially generated from the first sorbent material adsorbing the undesirable gas during the adsorption mode, wherein the first phase change material is configured to absorb the heat to enable the first sorbent material to operate between an upper temperature and a lower temperature during the adsorption mode.

14. The system of claim 13, wherein the first phase change material is configured to absorb the heat to enable the first sorbent material to operate in an isothermal operating mode.

15. The system of claim 1, comprising a conductive heat transfer path between the first sorbent material and the first phase change material.

16. The system of claim 1, wherein the first sorbent material is disposed directly on the first phase change material.

17. The system of claim 1, wherein the first sorbent material is disposed on a first side of a wall, the first phase change material is disposed on a second side of the wall, and the first and second sides are opposite to one another.

18. The system of claim 17, comprising an enclosure having the wall disposed about an interior portion, wherein the first phase change material is disposed in the interior portion, and the first sorbent material is disposed along an exterior surface of the wall.

19. A system, comprising:
a controller having a memory, a processor, and instructions stored on the memory and executable by the processor to:
selectively change operating modes of a gas capture system in a sequence of an adsorption mode, a desorption mode, and a cooling mode, wherein the gas capture system comprises a first adsorber having a first sorbent material and a first phase change material;
control a gas flow through the first adsorber in the adsorption mode, wherein the first sorbent material is configured to adsorb an undesirable gas from the gas flow during the adsorption mode, and the first phase change material is configured to absorb heat during the adsorption mode to increase a capacity of the first sorbent material to adsorb the undesirable gas;
control heating of the first adsorber in the desorption mode, wherein the heating causes desorption of the undesirable gas from the first sorbent material; and
control cooling of the first adsorber in the cooling mode, wherein the cooling regenerates the first phase change material prior to a subsequent operation in the adsorption mode.

20. A method, comprising:
selectively changing operating modes of a gas capture system in a sequence of an adsorption mode, a desorption mode, and a cooling mode, wherein the gas capture system comprises a first adsorber having a first sorbent material and a first phase change material;
controlling a gas flow through the first adsorber in the adsorption mode, wherein the first sorbent material is configured to adsorb an undesirable gas from the gas flow during the adsorption mode, and the first phase change material is configured to absorb heat during the adsorption mode to increase a capacity of the first sorbent material to adsorb the undesirable gas;
controlling heating of the first adsorber in the desorption mode, wherein the heating causes desorption of the undesirable gas from the first sorbent material; and
controlling cooling of the first adsorber in the cooling mode, wherein the cooling regenerates the first phase change material prior to a subsequent operation in the adsorption mode.
